(19) United States
(12) Patent Application Publication
(10) Pub. No.: US 2025/0383920 A1
(43) Pub. Date: Dec. 18, 2025

(54) SYSTEM AND METHOD FOR MITIGATING NON-UNIFORM MEMORY ACCESS CHALLENGES WITH COMPUTE EXPRESS LINK-ENABLED MEMORY POOLING

(71) Applicant: Georgia Tech Research Corporation, Atlanta, GA (US)

(72) Inventors: Alexandros Daglis, Atlanta, GA (US); Albert Cho, Atlanta, GA (US)

(21) Appl. No.: 19/237,951

(22) Filed: Jun. 13, 2025

Related U.S. Application Data
(60) Provisional application No. 63/660,268, filed on Jun. 14, 2024.

(51) Int. Cl. G06F 9/50; G06F 12/0842

(52) U.S. Cl. CPC G06F 9/5016; G06F 9/5088; G06F 12/0842; G06F 2209/5011

(57) ABSTRACT

An exemplary multi-socket system and method are disclosed for employing a memory pool configured with memory resources accessible to every core, at CPU sockets, of every multi-CPU-socket chassis in the system. The exemplary system can migrate, via one or more computer express links (CXL), heavily shared memory resources (e.g., vagabond pages) from a specific multi-CPU-socket chassis to the memory pool, where every core can access the shared memory resources in quick single-hop accesses, thereby mitigating performance bottlenecks caused by slow multi-hop memory accesses to the same memory resources.

### RELATED APPLICATION

This U.S. application claims priority to, and the benefit of, U.S. Provisional Patent Application No. 63/660,268, filed Jun. 14, 2024, entitled “STARNUMA: MITIGATING NUMA CHALLENGES WITH CXL-ENABLED MEMORY POOLING,” which is incorporated by reference herein in its entirety.

### BACKGROUND

High-performance computing (HPC) is a specialized computer system, often implemented in clusters, that can perform complex calculations and process large data sets at extremely high speeds. It is commonly used in scientific research, engineering, and business applications to solve problems that are too large or complex for standard computers. High-performance computing systems often rely on multi-socket systems having many cores to handle such workloads. In multi-socket systems, each socket may have a separate memory controller through a Northbridge that allows for high speed access by a respective socket. Northbridge is a microchip in a computer's motherboard that connects the CPU to high-speed components like RAM and graphics cards.

To scale up to 16 or more sockets, microprocessors are interconnected, often hierarchically, with Non-Uniform Memory Access (NUMA) that allows every microprocessor or associated cores to access any memory location native to that microprocessor or non-native to other microprocessors. Access by non-native processors on the same chassis/motherboard, while fast, still has more latency than that of the native microprhankocessor. Multi-socket computing hardware can be complex to implement.

There is a benefit to improving the multi-socket systems.

### SUMMARY

An exemplary multi-socket system and method are disclosed configured with common memory pool that can be directly access by each CPU sockets of multi-socket system through a high-speed serial link with a protocol that supports (i) native load/store memory operations and (ii) coherence where all processors or cores accessing shared memory see a consistent view of that memory. In some embodiments, the multi-socket employs a shared computer express link (CXL) as the serial link that connects among all of the CPU sockets of a given multi-socket chassis and among multiple multi-socket chassis. The serial link provides a separate memory pool resource to local page files to native L1 and L2 cache for each respective socket of the multi-socket chassis.

A study was conducted that identified joint page files as a heavily shared memory resources (e.g., vagabond pages) as bottlenecks in high-performance computing computation for non-native memory accesses. The study observed that when the heavily shared memory resources employed in the study was accessed via natively implemented memory pool through serial link with via native load/store memory operations (e.g., as single-hop accesses), the average memory access time (AMAT) of the workloads and computational tasks running on one or more of its sockets were improved between 10% and 30% for different tasks(.

A socket (also referred to herein as a CPU socket or a CPU slot) is a mechanical and electrical assembly on a motherboard designed to hold a microprocessor. A microprocessor as used herein refers to a single integrated circuit that contains all the functions of a central processing unit of a computer. The socket can house a microprocessor, which can have multiple processing units, or cores. Microprocessors can also house chiplets, ASICs, AI circuit, co-processors, and other digital hardware circuitries.

The exemplary system and method can be implemented as a high-performance computing platform or cluster for executing memory-intensive and latency-sensitive applications. The exemplary system can dynamically identify vagabond pages—memory pages that are frequently accessed by cores across multiple sockets—and relocate them to a centralized memory pool that is directly accessible via low-latency interconnects. This memory pooling configuration is transparent to applications and operating systems, requiring no modifications to software stacks.

The exemplary system can further include mechanisms for monitoring memory access patterns, determining memory page sharing intensity, and triggering migration decisions based on predefined thresholds. The memory pool can be implemented using CXL-attached memory modules, enabling disaggregated memory architectures that scale across multi-CPU-socket chassis. By reducing inter-socket traffic and improving memory locality through the use of a memory pool, the exemplary system can enhance overall throughput and energy efficiency in multi-socket environments.

The exemplary system and method can be beneficial in large-scale data centers and cloud computing infrastructures, where latency penalties (e.g., NUMA-induced latencies) can degrade performance. The exemplary system's ability to adaptively pool and manage shared memory resources can provide a scalable and efficient solution to NUMA challenges in modem computing platforms.

In an aspect, a system is disclosed comprising a memory pool configured with memory resources and service read and write requests to the memory resources; one or more multi-CPU-socket chassis forming a high-performance computing (HPC) system (e.g., centralized HPC, distributed HPC), including a first multi-CPU-socket chassis, wherein the first multi-CPU-socket chassis has a plurality of sockets, wherein each socket of the first multi-CPU-socket chassis is operatively coupled to the memory pool, wherein the first multi-CPU-socket chassis comprises: a plurality of processing units (e.g., CPU chiplets in a microprocessor, cores) connected to the plurality of sockets, including a first processing unit; and a plurality of local memories, including a first local memory, wherein the first local memory has instructions stored thereon, wherein execution of the instructions causes the plurality of processing units to: allocate a memory resource, from the first local memory, for a computing process, wherein the allocated memory resource is accessible by each of the plurality of processing units of the first multi-CPU-socket chassis; and migrate the allocated memory resource to the memory pool based on a number of tracked accesses to the allocated memory resource by the plurality of processing units, wherein the migrated allocated memory resource in the memory pool is directly accessible by the plurality of processing units without an access request being presented to the first processing unit.

In some embodiments, the one or more multi-CPU-socket chassis include a second multi-CPU-socket chassis having a second plurality of sockets, wherein each socket of the second multi-CPU-socket chassis is operatively coupled to the memory pool, wherein each of the second plurality of sockets is connected to a second plurality of local memories, and wherein each of the second plurality of sockets is connected to the memory pool.

In some embodiments, each of the one or more multi-CPU-socket chassis has a respective plurality of processing units (e.g., CPU chiplet in a microprocessor, cores) connected to a respective plurality of sockets, wherein each of the respective plurality of sockets of each of the one or more multi-CPU-socket chassis is connected to a respective plurality of local memories, and wherein each of the respective plurality of sockets of each of the multi-CPU-socket chassis is connected to the memory pool.

In some embodiments, each of the respective plurality of sockets is connected to the memory pool via a Compute Express Link (CXL).

In some embodiments, the memory pool is a multi-headed device (MHD) having one or more ports configured to support CXLs and CXL-enabled connections with each of the plurality of sockets.

In some embodiments, each of the respective plurality of sockets of each of the one or more multi-CPU-socket chassis is configured to transmit a page or cache line to subsequent multi-CPU-socket chassis via one or more inter-socket links of a respective inter-socket link application-specific integrated circuit (ASIC) of each of the one or more multi-CPU-socket chassis.

In some embodiments, the memory pool is located in the first multi-CPU-socket chassis.

In some embodiments, the memory pool is located in a separate circuitry (e.g., separate motherboard).

In some embodiments, the migrated allocated memory resource is a joint page accessible by the plurality of processing units in a joint computing process.

In some embodiments, each of the plurality of sockets receives a microprocessor having a plurality of cores or chiplets as a subset of the plurality of processing units.

In some embodiments, execution of the instructions further causes the plurality of processing units to: subsequent to allocating the memory resource, broadcast a notification message page or cache line, via one or more inter-socket links of a first inter-socket link ASIC of the first multi-CPU-socket chassis, notifying the subsequent multi-CPU-socket chassis of the presence of the allocated memory resource.

In some embodiments, the memory pool includes a controller configured to receive a page or cache line from or transmit the page or cache line to a respective plurality of sockets of a multi-socket CPU chassis.

In some embodiments, execution of the instructions further causes the plurality of processing units to: prior to migrating the allocated memory resource to the memory pool: transmitting a request message page or cache line, via a CXL, to the controller of the memory pool requesting availability for storing the allocated memory resource; and receiving, via the CXL, a reply message page or cache line from the controller of the memory pool indicating the availability for storing the allocated memory resource.

In some embodiments, execution of the instructions further causes the plurality of processing units to: subsequent to migrating the allocated memory resource to the memory pool: receiving, via the CXL, a confirmation message page or cache line from the controller of the memory pool confirming a completion of the migration of the allocated memory resource; broadcasting a notification message page or cache line, via the CXL, notifying subsequent multi-CPU-socket chassis of the presence of the allocated memory resource in the memory pool.

In some embodiments, the respective plurality of sockets of each of the one or more multi-CPU-socket chassis includes 2 to 64 sockets.

In some embodiments, the migration is handled by an operating system associated with the plurality of processing units, including the first processing unit.

In some embodiments, the migrated allocated memory resource is maintained by the operating system and owned (e.g., accessible) by the plurality of processing units.

In some embodiments, the allocation of the memory resource occurs on the memory pool, wherein the allocated memory resource on the memory pool is directly accessible by the plurality of processing units without an access request being presented to the first processing unit.

In another aspect, a method is disclosed comprising providing a memory pool configured with memory resources and service read and write requests to the memory resources, wherein the memory pool is accessible by a plurality of multi-CPU-socket chassis, including a first multi-CPU-socket chassis including (i) a plurality of processing units (e.g., CPU chiplets in a microprocessor, cores) connected to a plurality of sockets, including a first processing unit and (ii) a plurality of local memories, including a first local memory; allocating a memory resource from the first local memory for a computing process, wherein the allocated memory resource is accessible by each of the plurality of processing units of the first multi-CPU-socket chassis; tracking accesses to the allocated memory resource by the plurality of processing units; and migrating the allocated memory resource to the memory pool based on a number of tracked accesses, wherein the migrated allocated memory resource in the memory pool is directly accessible by the plurality of processing units without an access request being presented to the first processing unit.

In some embodiments, each of the plurality of sockets is connected to the memory pool via a Compute Express Link (CXL).

### BRIEF DESCRIPTION OF DRAWINGS

FIGS. 1A-1C each shows an example multi-socket system employing a memory pool configured with memory resources accessible to every core (also referred to as processing unit, central processing unit (CPU)), at central-processing-unit (CPU) sockets (also referred to as a processing socket) of every multi-CPU-socket chassis, to use, in accordance with an illustrative embodiment. In FIG. 1A, the memory pool is located on a separate circuitry (e.g., separate motherboard) in proximity to the multi-CPU-socket chassis. In FIG. 1B, the memory pool is located in a cloud infrastructure. In FIG. 1C, the memory pool is part (e.g., an extension) of a multi-CPU-socket chassis.

FIG. 2 shows an example super-computing platform comprising a plurality of modules (e.g., the system of FIG. 1A), each controlled by a global controller.

FIGS. 3A-3B each shows an example communication flow between cores and the memory pool.

FIG. 4 shows an example operation flow for the exemplary system in accordance with an illustrative embodiment.

FIGS. 5A and 5B show page access pattern characteristics evaluation for a multi-socket NUMA system.

FIGS. 6A-6B show a schematic of a multi-socket system employing a memory pool implemented in a study.

FIGS. 7A-71 show experimental results for the multi-socket system employing a memory pool implemented in a study.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

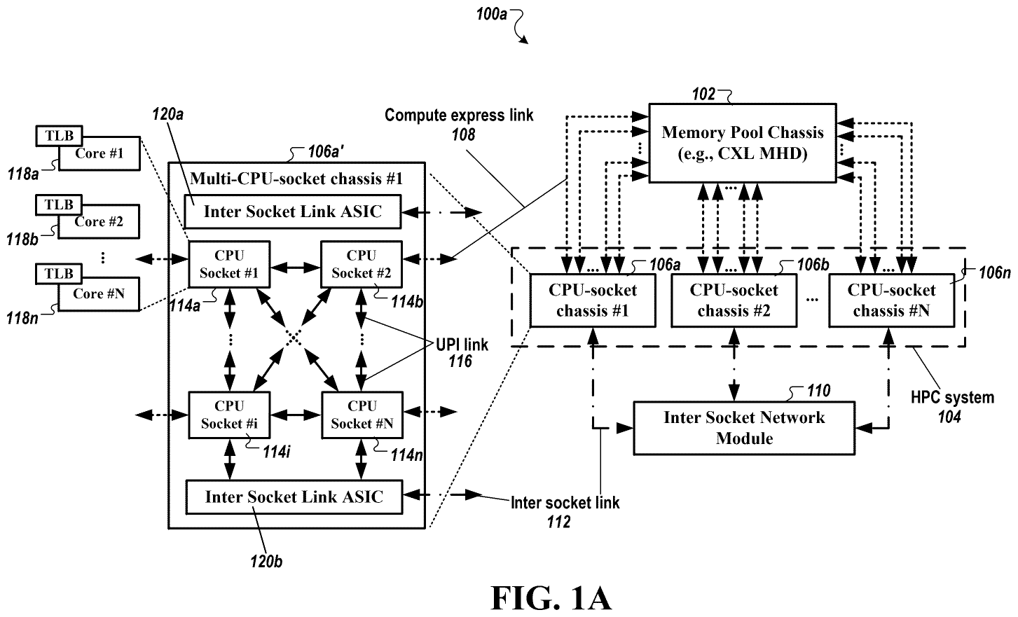

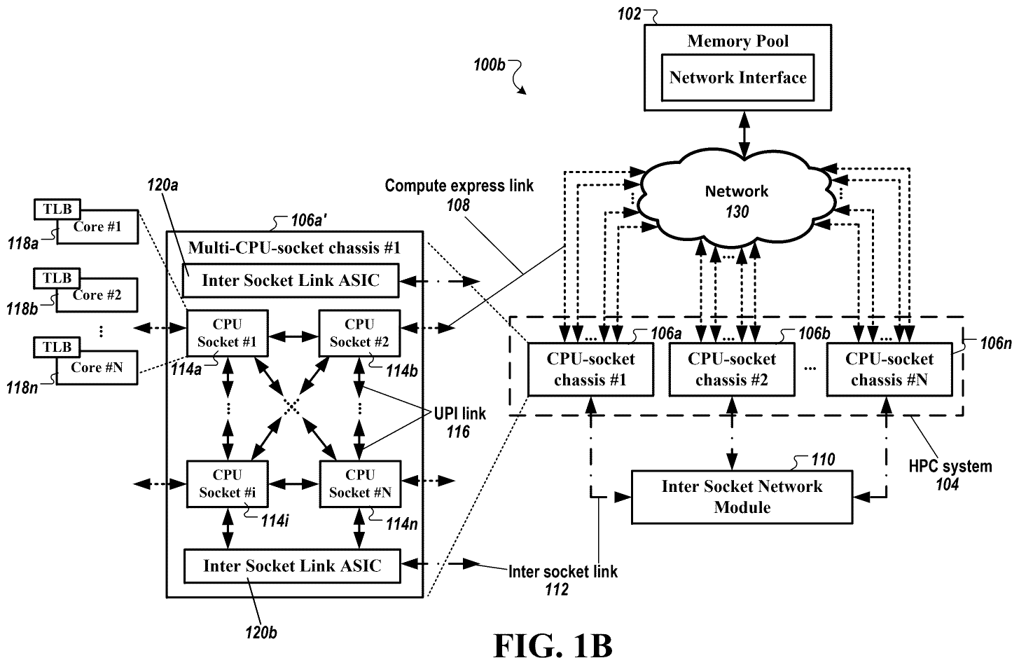

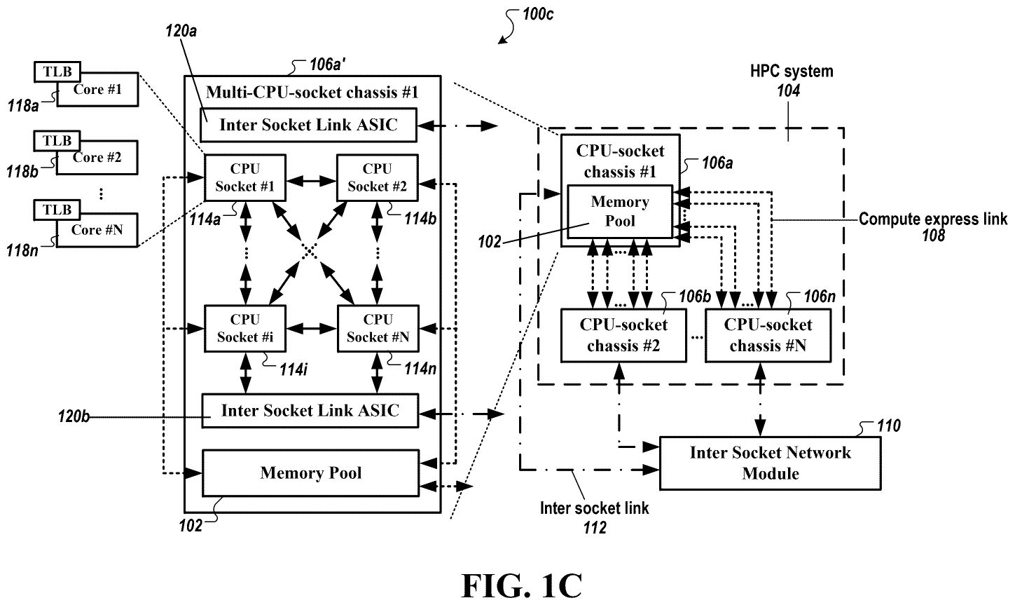

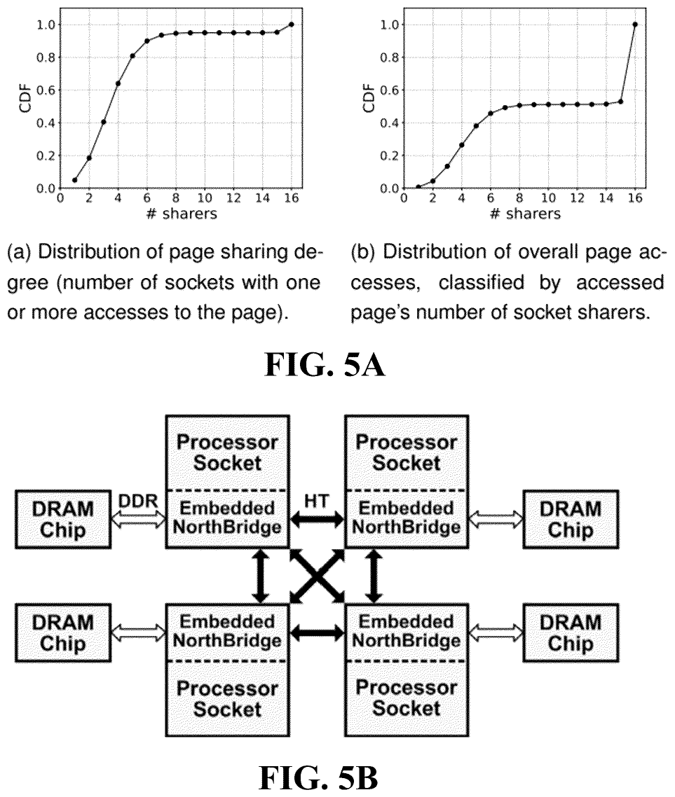

FIGS. 1A-1C each shows an example multi-socket system 100 (shown as 100a, 100b, 100c) employing a memory pool 102 configured with memory resources accessible to every core at the CPU sockets (e.g., 114, shown as 114a-114n) of a plurality of multi-CPU-socket chassis 106 (shown as 106a-106n), in accordance with an illustrative embodiment. In FIG. 1A, the memory pool 102 is located on a separate circuitry (e.g., separate motherboard or chassis) in proximity to the multi-CPU-socket chassis 106. In FIG. 1B, the memory pool 102 is located in a cloud infrastructure. In FIG. 1C, the memory pool 102 is part (e.g., an extension) of a multi-CPU-socket chassis 106 (e.g., 106a). Each socket 114 may have a separate memory controller through a Northbridge that allows for high-speed access by a respective socket (see, e.g., FIG. 5B). Northbridge is a microchip in a computer's motherboard that connects the CPU to high-speed components like RAM and graphics cards. The local memory controller can provide native L1 and L2 cache for each respective socket of the multi-socket chassis.

Memory Pool (102). In the example shown in FIG. 1A, the memory pool 102 is configured with memory resources that each core or processing unit (e.g., 118a-118n), via respective CPU sockets (e.g., 114a-114n), of each of the multi-CPU-socket chassis (e.g., 106a-106n) can send read/write requests to. A core, as used herein, refers to a processing unit that resides in a microprocessor IC. The memory pool 102 can be operatively coupled to every CPU socket (e.g., 114a-114n) of each of the multi-CPU-socket chassis (e.g., 106a-106n), via computer express links (CXLs) 108 to support the transmissions/migrations of pages or cache lines between the memory pool 102 and one or more cores of the respective CPU socket. The storing or loading of pages or cache lines at the memory pool can be controlled by a controller within the memory pool 102. The memory pool 102 can be configured as a multi-headed device (MHD) having one or more ports configured to support CXLs and CXL-enabled connections with every CPU socket (e.g., 114a-114n) of each of the multi-CPU-socket chassis (e.g., 106a-106n). Other high-speed serial links can be used by having a protocol that supports (i) native load/store memory operations and (ii) coherence.

In the example shown in FIG. 1B, the memory pool 102 (also referred to as auxiliary pool) is located in a cloud infrastructure having a network interface configured to (i) receive pages or cache lines from and (ii) send pages or cache lines to the multi-CPU-socket chassis (e.g., 106a-106n) through a cloud network 130 (e.g., internet).

In the example shown in FIG. 1C, the memory pool 102 is part (e.g., an extension) of the multi-CPU-socket chassis 106a and is still directly accessible to every CPU socket (e.g., 114a-114n) of each of the multi-CPU-socket chassis (e.g., 106a-106n) via the CXLs 108.

In some embodiments, the controller of the memory pool 102 (see FIGS. 1A-1C) can allocate its own memory resource (e.g., page, cache line) that is directly accessible to every core of every multi-CPU-socket chassis operatively coupled to the memory pool 102, irrespective of the location (e.g., separate local circuitry, cloud infrastructure, or specific multi-CPU-socket chassis) of the memory pool 102.

In some embodiments, the controller of the memory pool 102 can send, via the CXL 108, a reply message page or cache line to one or more cores of a multi-CPU-socket chassis, indicating the availability of the memory pool 102 for storing a memory resource allocated at the multi-CPU-socket chassis. In another set of embodiments, the controller of the memory pool 102 can send, via the CXL 108, a confirmation message page or cache line to one or more cores of a multi-CPU-socket chassis, confirming the completion of a migration to the memory pool 102, of a memory resource allocated at the multi-CPU-socket chassis. In yet another set of embodiments, the controller of the memory pool 102 can broadcast, via the CXL 108, a notification page or cache line to every multi-CPU-socket chassis (e.g., 106a-106n), notifying the multi-CPU-socket chassis of the presence of one or more memory resources (e.g., pages, cache lines) that the controller of the memory pool 102 allocates itself or receives from one or more cores of a multi-CPU-socket chassis.

### Multi-CPU-Socket Chassis (106).

In the examples shown in FIGS. 1A-1C, the multi-CPU-socket chassis 106 (shown as 106a-106n) can form a high-performance computing (HPC) system (e.g., centralized HPC, distributed HPC). Each socket may have a local memory controller through a Northbridge that allows for high-speed access by a respective socket. Northbridge is a microchip in a computer's motherboard that connects the CPU to high-speed components like RAM and graphics cards.

The CPU sockets in each of the multi-CPU-socket chassis can additionally communicate (e.g., send/receive messages) via an inter-socket network module 110 formed by inter-socket links 112 with the CPU sockets in every other multi-CPU-socket chassis.

Each multi-CPU-socket chassis (e.g., 106a, shown as 106a′) can have 2 to 64 CPU sockets. Each CPU socket (e.g., 114a) can be (i) shared by a plurality of cores (e.g., 118a-118n) and (ii) operatively coupled to the memory pool 102 so that the plurality of cores (e.g., 118a-118n) can migrate memory resources (e.g., pages, cache lines) to or receive messages (e.g., notification, confirmation pages, cache lines) from the memory pool 102 via the CXL 108. Each core can have a translation lookaside buffer (TLB) configured to cache address translations of pages or cache lines (e.g., an allocated memory resource migrated from one core to the memory pool) stored in a page table associated with the multi-CPU-socket chassis employing the cores.

The CPU sockets (e.g., 114a-114n) in a multi-CPU-socket chassis (e.g., 106a) can locally communicate (e.g., exchanging resources, e.g., pages/cache lines) via ultra-path interconnect (UPI) links 116 with one another. The CPU sockets (e.g., 114a-114n) in the same multi-CPU-socket chassis (e.g., 106a) can also communicate (e.g., exchanging resources, e.g., pages/cache lines) via the inter-socket network module 110 formed by inter-socket links 112 with the CPU sockets in every other multi-CPU-socket chassis (e.g., 106b-106n). The inter-socket links 112 connect the inter-socket link application-specific integrated circuits (ASICs) (e.g., 120a-120b) of the same multi-CPU-socket chassis (e.g., 106a) with the inter-socket link ASICs of other multi-CPU-socket chassis (e.g., 106b-106n), forming the inter-socket network module 110 for the CPU sockets of every multi-CPU-socket chassis to globally communicate with one another.

In one embodiment, a plurality of cores (e.g., 118a-118n) at one or more CPU sockets (e.g., 114a-114n) of a multi-CPU-socket chassis (e.g., 106a) can allocate a memory resource (e.g., joint page), on a local memory of the resource-allocating multi-CPU-socket chassis (e.g., 106a), accessible to every other core of the resource-allocating multi-CPU-socket chassis (e.g., 106a) and to every other core of other multi-CPU-socket chassis (e.g., 106b-106n). The plurality of cores (e.g., 118a-118n) of the resource-allocating multi-CPU-socket chassis (e.g., 106a) can keep track of the number of accesses to the allocated memory resource. When the number of tracked accesses to the allocated memory resource exceeds a threshold number, the plurality of cores of the resource-allocating multi-CPU-socket chassis (e.g., 106a) can migrate via the CXL links 108 the allocated resource to the memory pool 102, where the migrated allocated memory resource in the memory pool 102 can be directly accessed by every core of every multi-CPU-socket chassis (e.g., 106a-106n) operatively coupled to the memory pool 102. The migration of the allocated memory resource can be handled by an operating system associated with the plurality of cores (e.g., 118a-118n) of the resource-allocating multi-CPU-socket chassis (e.g., 106a). The migrated allocated memory resource can be maintained by the operating system and owned (e.g., accessible) by the plurality of cores (e.g., 118a-118n) of the resource-allocating multi-CPU-socket chassis.

In another embodiment, before migrating the allocated memory resource to the memory pool 102, the plurality of cores (e.g., 118a-118n) of the resource-allocating multi-CPU-socket chassis (e.g., 106a) can (i) transmit a request message page or cache line, via the CXL 108, to the controller of the memory pool 102 requesting availability of the memory pool 102 for storing the allocated memory resource and (ii) receive, via the CXL 108, a reply message page or cache line from the controller of the memory pool 102 indicating the availability of the memory pool 102 for storing the allocated memory resource.

In yet another embodiment, after migrating the allocated memory resource to the memory pool 102, the plurality of cores (e.g., 118a-118n) of the resource-allocating multi-CPU-socket chassis (e.g., 106a) can (i) receive, via the CXL 108, a confirmation message page or cache line from the controller of the memory pool 102 confirming completion of the migration of the allocated memory resource and (ii) broadcast, via the CXL 108, a notification message page or cache line notifying every other multi-CPU-socket chassis (e.g., 106b-106n) of the presence of the allocated memory resource in the memory pool 102.

### Example Super-Computing Platform

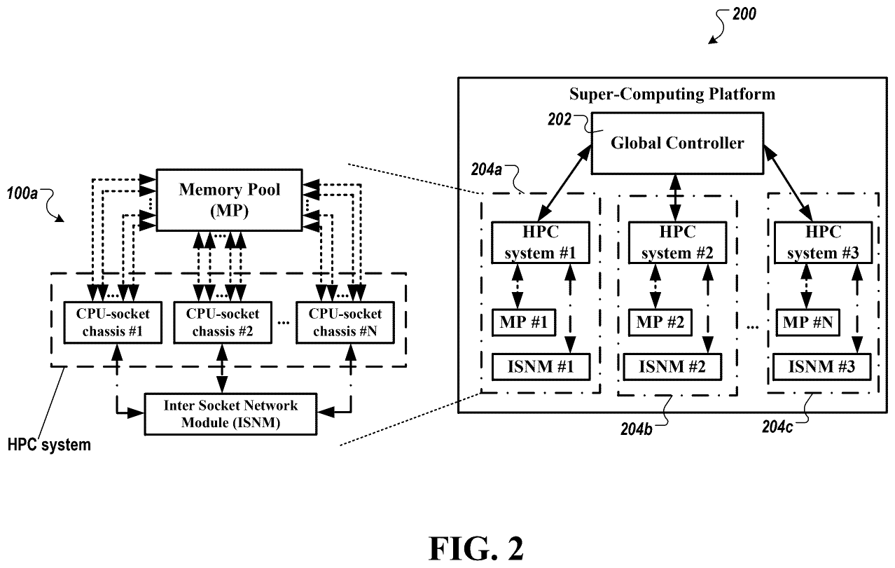

FIG. 2 shows an example super-computing platform 200 comprising a plurality of modules 204a-204c, each controlled by a global controller 202. Each of the modules 204 can be implemented as the system 100a (see FIG. 1A), comprising (i) an HPC system formed by one or more CPU-socket chassis, (ii) a memory pool, and an inter-socket network module.

### Example Communication Flow for Cores and Memory Pool

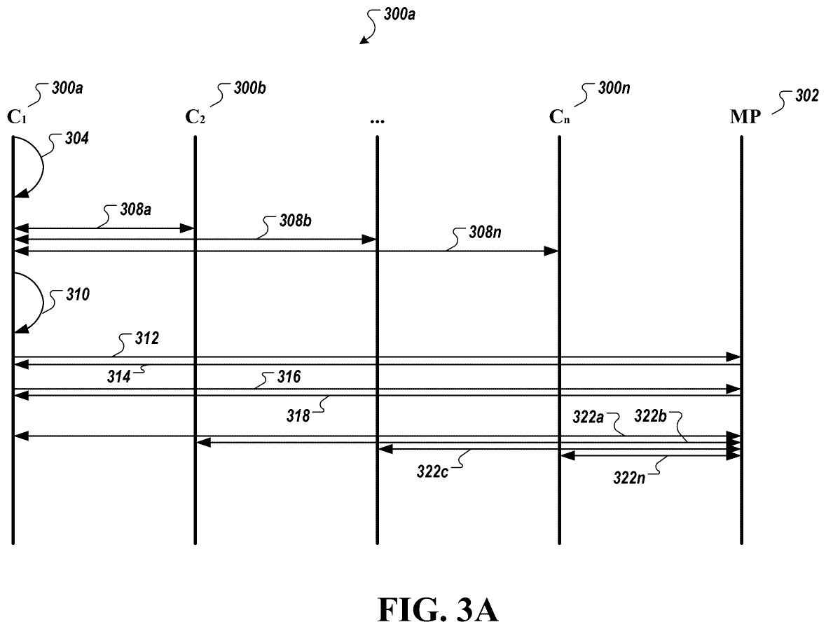

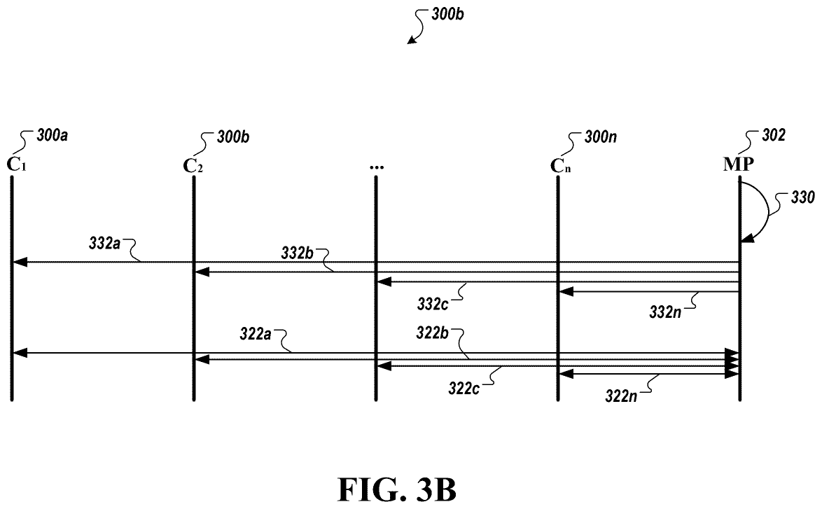

FIGS. 3A-3B each shows an example operation 300 (shown as 300a-300b) between cores (see 118, FIGS. 1A-1C) and the memory pool (see 102, FIGS. 1A-1C). In the examples shown in FIG. 3A-3B, all the cores 118 (shown as 118a-118n) may be on the same or different multi-CPU-socket chassis (see 106, FIGS. 1A-1C), but all the cores 300 can (i) communicate (e.g., exchange messages and resources, e.g., pages/cache lines), via inter-socket links (see 112, FIGS. 1A-1C), with one another and (ii) communicate (e.g., exchange messages and resources, e.g., pages/cache lines), via computer express links (see 108, FIGS. 1A-1C), with the memory pool 102.

In FIG. 3A, operation 300a begins when core 118a (shown as C₁) allocates a memory resource (e.g., joint page) from its local memory for a computing process. The allocated memory resource is accessible to each of the cores 300b-300n (shown as C₂-Cₙ) through the core 118a, and one or more cores 300b-300n can send read and write requests 118a-118n to the core 118a to use/manipulate the allocated memory resource. In some embodiments, after allocating the memory resource, the core 118a broadcasts, via one or more inter-socket links of its inter-socket link ASIC (see 120, FIGS. 1A-1C), a notification message page or cache line notifying each of the cores 118b-118n of the presence of the allocated memory resource, so that the cores 300b-300n can start using the allocated memory resource.

The core 118a can keep track (310) of the number of cores accessing the allocated memory resource. When the number of tracked accesses to the allocated memory resource exceeds a threshold value, the core 118a can transmit (312), via a CXL, a request message page or cache line to the controller of the memory pool 102 requesting availability for storing the allocated memory resource. The controller of the memory pool 102 then transmits (314), via the CXL, a reply message page or cache line back to the core 118a, indicating the availability for storing the allocated memory resource. If the reply message page or cache line indicates that the memory pool 302 has sufficient storage for the allocated memory resource, the core 118a can migrate (316) via the CXL the allocated memory resource to the memory pool 302.

After the migration is complete, the controller of the memory pool 302 can transmit (318), via the CXL, a confirmation message page or cache line back to the core 118a, confirming the completion of the migration of the allocated memory resource. The migrated allocated memory resource can be accessible via the CXL to every core 118a-118n, and one or more cores 118a-118n can send read and write requests 322a-322n to the memory pool 302 to use/manipulate the migrated allocated memory resource.

In some embodiments, after receiving the confirmation message page or cache line from the controller of the memory pool 302, the core 118a can broadcast, via the CXL, a notification message page or cache line notifying the core 118b-118n of the presence of the migrated allocated memory resource in the memory pool 302, so that the cores 118b-118n can start using the migrated allocated memory resource. The broadcasting process of core 118a can comprise two steps. First, the operating system (OS), associated with cores 118a-118n, sends a TLB shoot-down message page or cache line to every core that may have an address translation for the migrated allocated memory resource cached in the respective local TLB to ensure that there are no stale translations in the exemplary system. The OS then updates the page table (i.e., the data structure that holds translations of the virtual page to a physical page, i.e., information on their physical location in the local memories of the cores) shared by the cores 118a-118n, so that the new location of the migrated allocated memory resource is recorded. Thus, when a core subsequently tries to access the migrated allocated memory resource next, the core may not find the translation in its TLB (since the translation was shot down in the first step) and may look in the page table, thereby retrieving the correct address translation/physical location of the migrated allocated resource.

In FIG. 3B, the controller of the memory pool 302 allocates (330) a memory resource (e.g., joint page). Then, the controller of the memory pool 302 can broadcast (332a-332n), via a CXL, a notification message page, or a cache line notifying the core 118a-300n of the presence of the allocated memory resource in the memory pool 302. The broadcasting process is in the same configuration as described in FIG. 3A. After being notified of the presence of the allocated memory resource, one or more cores 300a-300n can send, via the CXL, read or write requests 322a-322n to the controller memory pool 302 to use/manipulate the allocated memory resource.

### Example Method

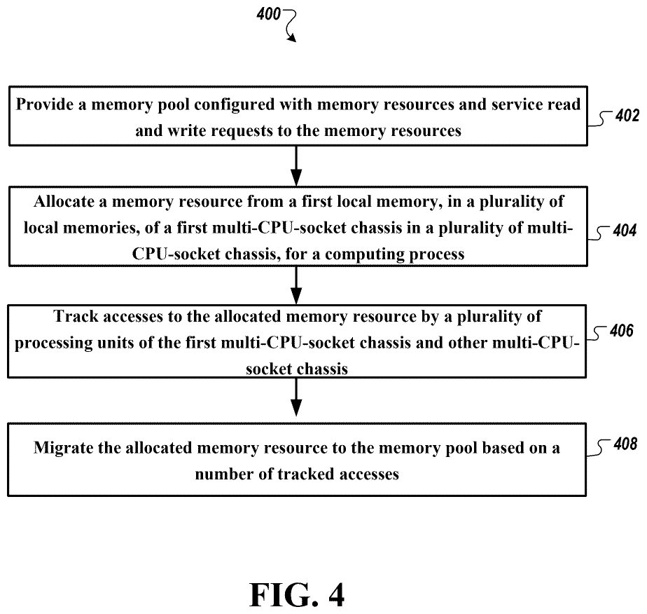

FIG. 4 shows an example operation flow 400 for the exemplary system in accordance with an illustrative embodiment. The method 400 includes providing (402) a memory pool configured with memory resources and service read and write requests to the memory resources. Method 400 includes allocating (404) a memory resource from a first local memory, in a plurality of local memories, of a first multi-CPU-socket chassis in a plurality of multi-CPU-socket chassis, for a computing process. Method 400 includes tracking (406) accesses to the allocated memory resource by a plurality of processing units of the first multi-CPU-socket chassis and other multi-CPU-socket chassis. Method 400 includes migrating (408) the allocated memory resource to the memory pool based on a number of tracked accesses.

In another aspect, the method includes providing a memory pool configured with memory resources and service read and write requests to the memory resources, wherein the memory pool is accessible by a plurality of multi-CPU-socket chassis, including a first multi-CPU-socket chassis comprising (i) a plurality of processing units connected to a plurality of sockets, including a first processing unit and (ii) a plurality of local memories, including a first local memory; allocating a memory resource from the first local memory for a computing process; and writing to the allocated memory resource of the memory pool based on the computing process, wherein the allocated memory resource in the memory pool is directly and natively accessible by the plurality of processing units without an access request being presented to one of the processing units.

In some embodiments of either method, the multi-CPU-socket chassis include a second multi-CPU-socket chassis having a second plurality of sockets, wherein each socket of the second multi-CPU-socket chassis is operatively coupled to the memory pool, wherein each of the second plurality of sockets is connected to a second plurality of local memories, and wherein each of the second plurality of sockets is connected to the memory pool.

In some embodiments of either method, each of the one or more multi-CPU-socket chassis has a respective plurality of processing units connected to a respective plurality of sockets, wherein each of the respective plurality of sockets of each of the one or more multi-CPU-socket chassis is connected to a respective plurality of local memories, and wherein each of the respective plurality of sockets of each of the multi-CPU-socket chassis is connected to the memory pool.

In some embodiments of either method, each of the respective plurality of sockets is connected to the memory pool via a Compute Express Link (CXL).

In some embodiments, the memory pool is a multi-headed device (MHD) having one or more ports configured to support CXLs and CXL-enabled connections with each of the plurality of sockets.

In some embodiments of either method, each of the respective plurality of sockets of each of the one or more multi-CPU-socket chassis is configured to transmit a page or cache line to subsequent multi-CPU-socket chassis via one or more inter-socket links of a respective inter-socket link application-specific integrated circuit (ASIC) of each of the one or more multi-CPU-socket chassis.

In some embodiments of either method, the memory pool is located in the first multi-CPU-socket chassis.

In some embodiments of either method, the memory pool is located in a separate circuitry.

In some embodiments of either method, the migrated allocated memory resource is a joint page accessible by the plurality of processing units in a joint computing process.

In some embodiments of either method, each of the plurality of sockets receives a microprocessor having a plurality of cores or chiplets as a subset of the plurality of processing units.

In some embodiments of either method, the execution of the instructions further causes the plurality of processing units to, subsequent to allocating the memory resource, broadcast a notification message page or cache line via one or more inter-socket links of a first inter-socket link ASIC of the first multi-CPU-socket chassis, notifying the subsequent multi-CPU-socket chassis of the presence of the allocated memory resource.

In some embodiments of either method, the memory pool comprises a controller configured to receive a page or cache line from or transmit the page or cache line to a respective plurality of sockets of a multi-socket CPU chassis.

In some embodiments of either method, the execution of the instructions further causes the plurality of processing units to prior to migrating the allocated memory resource to the memory pool: transmitting a request message page or cache line, via a CXL, to the controller of the memory pool requesting availability for storing the allocated memory resource; and receiving, via the CXL, a reply message page or cache line from the controller of the memory pool indicating the availability for storing the allocated memory resource.

In some embodiments of either method, the execution of the instructions further causes the plurality of processing units to, subsequent to migrating the allocated memory resource to the memory pool, receive, via the CXL, a confirmation message page or cache line from the controller of the memory pool confirming a completion of the migration of the allocated memory resource; and broadcasting a notification message page or cache line, via the CXL, notifying subsequent multi-CPU-socket chassis of the presence of the allocated memory resource in the memory pool.

In some embodiments of either method, the respective plurality of sockets of each of the one or more multi-CPU-socket chassis includes 2 to 64 sockets.

In some embodiments of either method, the migration is handled by an operating system associated with the plurality of processing units, including the first processing unit.

In some embodiments of either method, the migrated allocated memory resource is maintained by the operating system and owned by the plurality of processing units.

In some embodiments of either method, the allocation of the memory resource occurs on the memory pool, wherein the allocated memory resource on the memory pool is directly accessible by the plurality of processing units without an access request being presented to the first processing unit.

### Experimental Results and Additional Examples

A study was conducted to develop large multi-socket machines for challenging high-performance computing. The study identified workloads with irregular memory access patterns as posing a challenge in multi-socket systems, as they exhibit a large fraction of vagabond pages—i.e., pages without a natural home socket. As a result, even intelligent data placement and migration techniques cannot eliminate costly remote memory accesses, which inflate AMAT and hurt performance. To alleviate this problem, the study developed and evaluated STARNUMA, a NUMA architecture augmented with the new architectural block of a memory pool that is directly accessible from every socket. Such a memory pool, accessible 2× faster than the worst-case NUMA latency, was implemented by leveraging the emerging CXL interconnect technology, making STARNUMA a practical design. The study showed that, by placing vagabond pages in the memory pool, STARNUMA significantly reduced the fraction of long-latency 2-hop memory accesses, reducing the AMAT of the graph and HPC workloads by 9% and yielding performance gains of up to 1.29×, and 1.13× on average.

StarNUMA is an enhanced/extended version of the state-of-the-art NUMA systems (i.e., baseline NUMA systems). The building block of NUMA architectures is a CPU socket featuring multiple cores and locally attached DRAM memory. These sockets can be interconnected with coherent links, referred to as Ultra Path Interconnect (UPI). A capability enabled by such interconnection is that every processor can directly access any other processor's memory using unmodified load/store instructions.

### Access Pattern Characteristics.

FIG. 5A shows page access pattern characteristics for the connected component (CC) workload from the graph algorithm platform (GAP) benchmark suite [8] on a 16-socket NUMA system. The more sharers a page has, the less affinity it has to any location. Subpanel (a) shows that 93% of pages have 8 sharers or fewer, indicating that an intelligent migration policy can place pages so that costly 2-hop accesses are minimized. However, while only 7% of pages have more than 8 sharers (subpanel (a)), 51% of all memory accesses are concentrated in those shared pages (subpanel (b)), and the 5% of pages shared by all 16 sockets account for 47% of all accesses. These accesses may be evenly distributed across sockets; 75% of them are inter-chassis.

The data in FIG. 5A indicates that a small memory pool that is accessible faster than an inter-chassis memory access can boost performance by accelerating a substantial fraction of memory accesses. FIG. 5B shows an example multi-socket CPU computing system configured with local memory employed for the comparison.

### Experimental System Implementation.

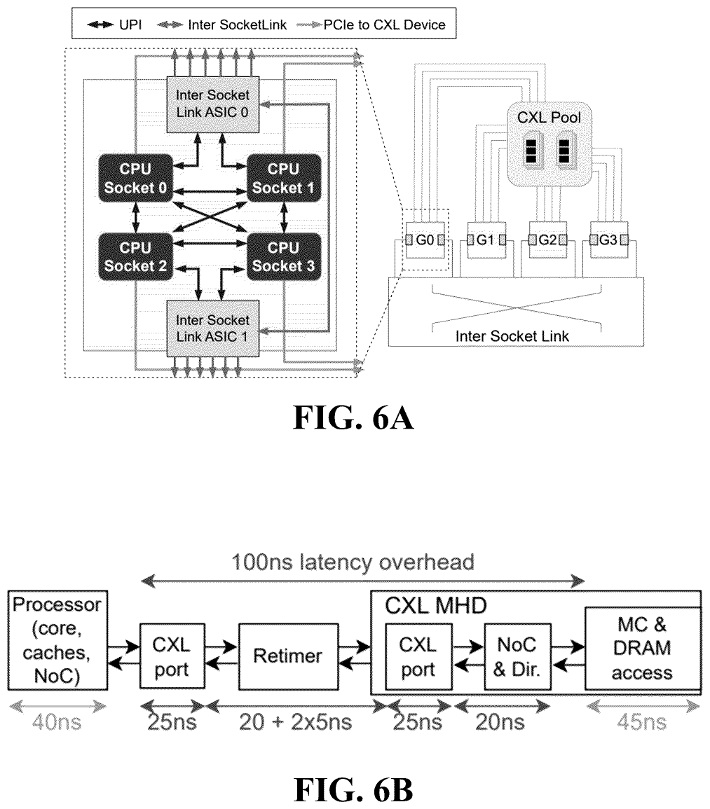

FIG. 6A shows a schematic of the system (“StarNUMA”) developed in an experiment of the study. As shown, the CXL memory pool directly connects to all sockets in a star topology. The chassis containing the CXL pool can be placed between the four CPU-socket chassis to minimize its distance from them and, hence, the number of required CXL retimers, which can add latency overhead.

In the study, every socket of the baseline 16-socket NUMA system can be equipped with PCIe-6.0-based CXL-3.0 ports that support the CXL.mem protocol, which the system of the study can use to drive direct links from each socket to the memory pool. Hence, the system of the study may not require any modifications to the processor socket.

### CXL Memory Pool Configuration.

The memory pool (see FIGS. 1A-1C, FIG. 6A) can be a type-3 device (e.g., a Multi-Headed Device (MHD)) [14] that features multiple CXL ports to support direct connections to every processor socket. The CXL MHD device can support dynamic partitioning, which can facilitate allocating multiple non-overlapping Host-managed Device Memory segments to be assigned to different hosts on demand [22], [33]. When the system was used in a scale-up setting, its memory pool can be actively shared by all sockets and, therefore, may not utilize the MHD's partitioning capability. Instead, the memory pool may require cache coherence, which is supported by CXL-3.0's Back-Invalidate protocol extensions. A cache coherence state can be maintained in a directory on the memory pool MHD.

In terms of memory capacity and bandwidth, the MHD may have capabilities equivalent to a processor chassis, i.e., four processor sockets. Given the baseline processor configuration, which featured 6 32 GB channels per socket (see Table 2), such provisioning corresponded to 24 DDR5 channels providing access to 768 GB of memory. However, these characteristics should be customizable, which can be a strength of a disaggregated memory design. The study also considered and evaluated different memory pool capacities in later sections.

### Memory Pool Connectivity.

In the study, each socket was directly connected to the memory pool over a dedicated CXL link. As CXL3.0's underlying physical layer was PCIe6.0, a four-lane CXL link provided the processor with 32 GB/s of raw bandwidth to the pool in each direction. While header and other communication overheads over the CXL port varied depending on the specific access pattern and read/write ratio [47], the study modeled a 62% conversion rate for a realized bandwidth (goodput) of 20 GB/s per direction.

Four PCIe-6.0 lanes had a modest requirement of only eight processor pins. To illustrate, a single ECC-enabled DDR4 channel can require over 160 processor pins [27]; DDR5 even more [44]. The study chose to use four lanes per processor in the system to match each socket's supported pool bandwidth to that of an intra-chassis UPI link. The study also considered other bandwidth ratios in the experiments.

Given the pin requirements, scaling the CXL links to ×8 or even ×16 PCIe ports may be realistic, thereby doubling or quadrupling the available bandwidth to the memory pool. The challenge may lie in supporting the aggregate number of lanes on the memory pool's MHD, but even with ×16 links on each processor, a 16-socket system may require a total of 256 lanes. AMD EPYC processors featured up to 128 lanes [5], while the majority of their silicon area was occupied by processors and SRAM. Hence, the study expected that the memory pool's MHD can scale to at least 16×8 ports, which can provide each socket with 64 GB/s of raw (or ˜40 GB/s effective) bandwidth to the memory pool.

The study derived latency values from Pond's [33] CXL MHD, given its similarities with the system's memory pool at the hardware level. The main distinction that can introduce latency differences is that the system of the study enforced coherence to implement truly shared memory. The CXL-3.0 whitepaper [14] suggested there was no latency difference between single-owner and multi-owner (where coherence may be enforced) memory segments, likely because a directory lookup was required regardless: either to check the coherence state or to confirm the owner of each memory request (even for single-owner memory segments). Nevertheless, the study included an additional 5 ns overhead in the CXL MHD over Pond's latency breakdown.

### Example Compute Express Link and Memory Pooling

The Compute Express Link (CXL) [14] is an open interconnect standard configured to provide a unified solution for coherent accelerators, non-coherent I/O devices, and memory expansion devices.

CXL is configured to attach memory modules several dozen centimeters away from the processor without a re-timer, thanks to its underlying serial interface. In contrast, a double-data-rate-attached (DDR-attached) memory must be placed close to the processor to preserve signal integrity. This configuration of CXL facilitates the creation of new memory systems featuring disaggregated memory. Furthermore, such disaggregated memory modules, referred to as a memory pool, can directly connect to multiple hosts and support hardware-enforced coherence. Pond [33] demonstrated the flexibility and utility of such a building block in the context of a scale-out architecture. To mitigate the challenge of memory stranding, Pond's CXL-enabled memory pool allows multiple virtual machines (VMs) in the same rack to dynamically resize their memory capacity by transparently expanding their local memory with remote memory borrowed from the shared memory pool.

The system of the study can utilize memory pooling to mitigate the challenges of data placement and associated NUMA issues. The system is a multi-socket system augmented with a coherent memory pool that directly connects to every socket, so the memory pool is accessible at a lower latency than the worst-case 2-hop latency. Pond [33] demonstrated that a similar CXL-enabled memory pool is accessible within 180 ns, which is approximately 40% slower than a single-hop NUMA access but 2× faster than a 2-hop access. Hence, with a placement/migration policy that can identify and place vagabond memory pages (i.e., pages without a natural home location because of active sharing by multiple sockets) in the memory pool, the system can improve AMAT by converting slow inter-chassis accesses to faster memory pool accesses.

### Latency Analysis.

FIG. 6B illustrates an example latency breakdown for the system's memory pool accesses. Memory requests leaving the processor toward the memory pool traversed the processor's CXL port and the HDM's CXL port, each of which added a 25-ns round-trip overhead. With 16 sockets, a re-timer may be implemented between each host and the HDM, adding 20 ns, and flight time on the link was about 5 ns per direction. Finally, traversing the NOC and internal arbitration logic before reaching the memory controller on the MHD was approximately 20 ns. Thus, summing up all these latency components, the overhead to access memory at the shared pool was about 100 ns. Including on-processor time and DRAM access, the end-to-end latency of accessing the memory pool was about 185 ns.

While the study focused on a 16-socket configuration for the system, it is possible to scale the system to 32 sockets and beyond. However, further scaling may require the introduction of CXL switches, each adding about 90 ns round-trip latency for a total memory pool access latency of about 275 ns. On the one hand, the latency gap between a memory pool access and a two-hop NUMA access may shrink, reducing the appeal of a shared memory pool. On the other hand, if scaling the baseline 16-socket NUMA system to 32 sockets and beyond introduces even longer worst-case NUMA delays, the memory pool approach may remain a viable option. The study conducted a brief latency sensitivity experiment, but the evaluation mainly focused on 16-socket systems.

### Page Monitoring and Migration.

The system's contribution is the introduction of a new architectural block for current state-of-the-art NUMA systems and the demonstration of its potential utility when used to host vagabond pages. To leverage an effective deployment of the system, a lightweight mechanism that can monitor page access patterns and identify those vagabond pages for pool placement is essential. Such system-level support is essential even in baseline 16-socket NUMA and tiered-memory systems and is a challenging ongoing research topic [4], [15], [29], [35], [39], [40]. Differences in memory architecture may affect the optimality of such migration policies and mechanisms; for example, previous studies showed that hybrid systems featuring memory that is both distributed and tiered require specially designed memory management to accommodate the unique characteristics of the memory architecture, i.e., policies designed for either distributed or tiered memory alone fall short [29].

In the study, a new architectural block was developed for the current state-of-the-art large-scale NUMA systems to implement the system. Therefore, optimal management of the new memory architecture may also require systems-level work that includes revisiting or developing new migration mechanisms. The study employed an optimistic (but not ideal or oracular) page monitoring and migration mechanism to evaluate both the system and the baseline 16-socket NUMA system.

### Evaluation Methodology.

The study evaluated the baseline system and the system in simulation. However, run-to-completion simulations of the entire target system can be impractical to evaluate the system for two reasons. First, the simulations should capture several page migration decision intervals, which occur at granularities of billions of instructions. Second, the large scale of the target multi-socket systems, featuring an aggregate of several hundred cores, can exacerbate the impracticality of cycle-level simulations. Thus, to address these two challenges, the study developed an evaluation methodology featuring a multi-step, sampling-based approach and mixed-modality simulation.

Simulating multisocket workloads long enough to capture several migration intervals requires tens of billions of instructions per core. Simulating at such a scale and cycle level can require prohibitive runtimes and resources. To address this challenge, the study resorted to a multi-step sampling-based simulation. Inspired by the SMARTS [55] methodology, the study constructed a similar sampling-based approach tailored to the inherent characteristics of the target system (e.g., baseline 16-socket NUMA system, system) to capture the effects of data placement and migrations.

Simulating an entire multi-socket system (16 sockets with dozens of cores each) at the cycle level remains impractical even with a sampling-based approach. To mitigate this challenge, the study extended the temporal sampling approach to spatial as well by (i) only simulating one socket in detail and abstracting the remaining sockets as load generators and memory request service endpoints (referred to as “light sockets”), and (ii) scaling down the number of simulated cores on the socket modeled in detail.

### Multi-Step Sampling-Based Simulation.

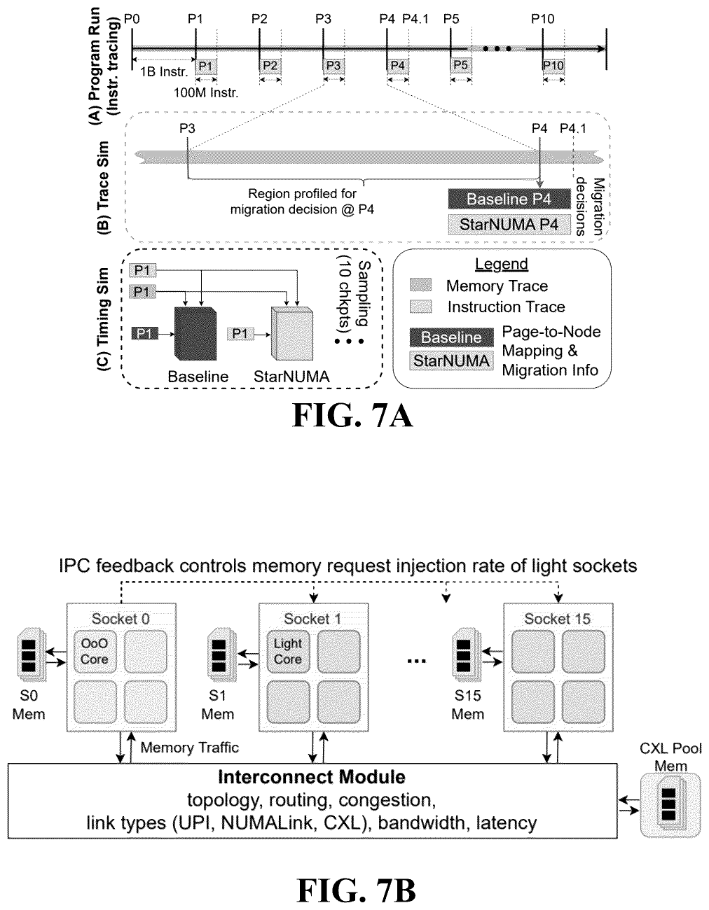

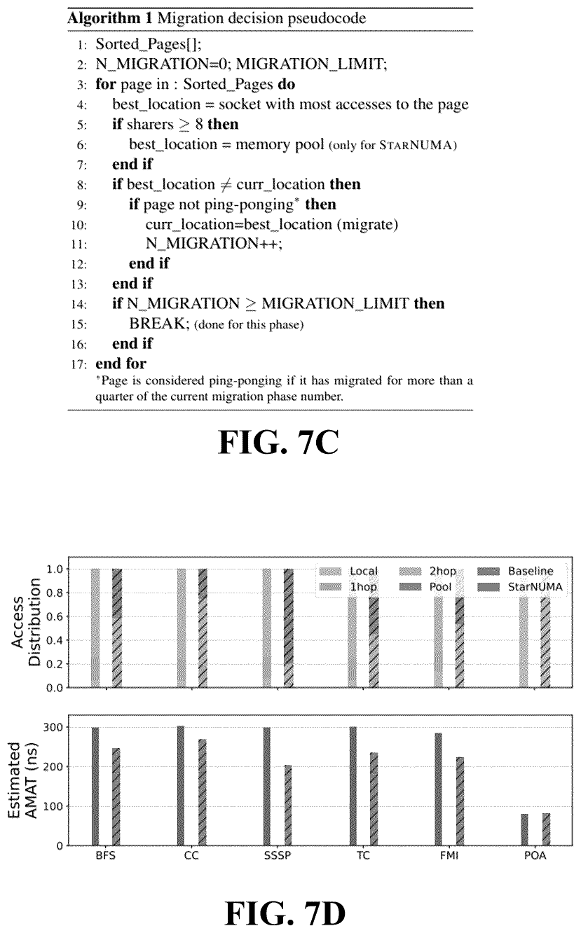

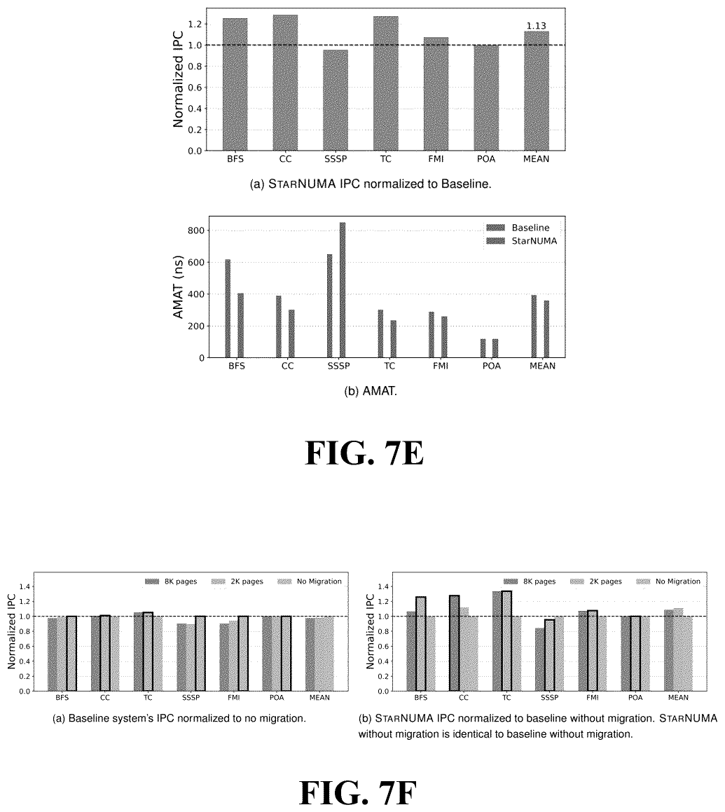

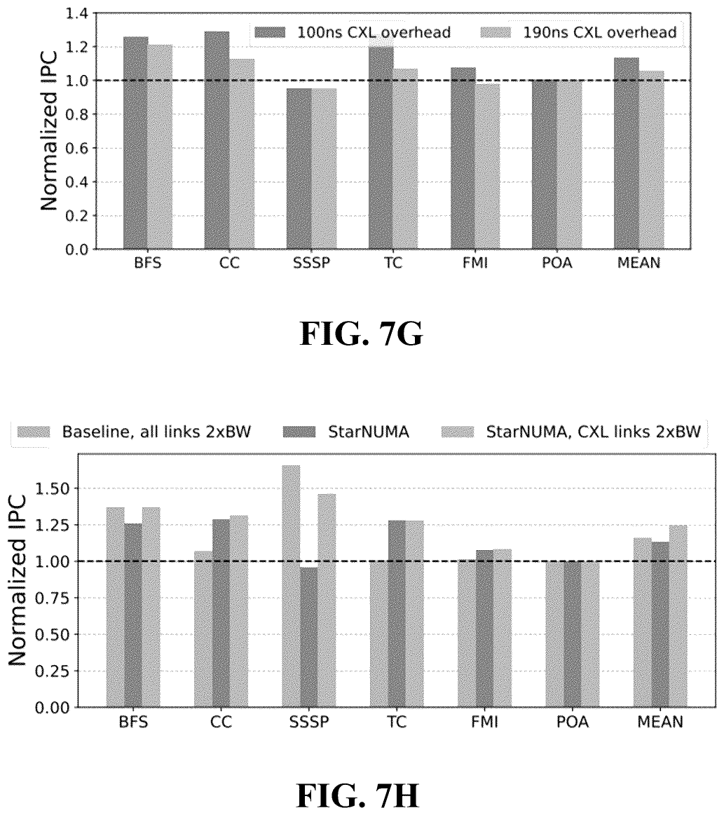

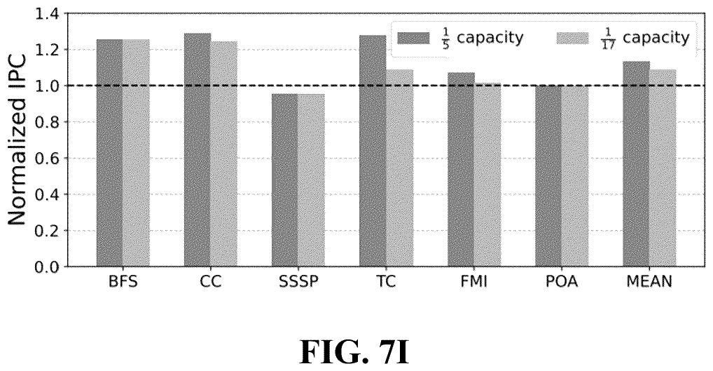

FIG. 7A shows an overview of a three-step sampling-based simulation for a multi-socket system (e.g., system, baseline system). In step A, the study first collected instructions and memory traces on real hardware. At step B, the study fed the memory traces into a memory trace simulator, making data migration decisions at time intervals typical of modem systems. Finally, at step C, the study simulated each of these intervals, along with its associated data movement decisions, at the cycle level in ChampSim [1].

Table 1 shows the descriptions for step A-C of the sampling-based simulation.

TABLE 1

| Step | Description |
|---|---|
| Step A - Instruction and | The study deployed the workload of interest on a real machine and used a |
| Memory Access Tracing | tracer to capture each thread's instruction trace. The tracer fulfilled two |
| | roles: it generated instruction traces for the cores (threads) of the socket |
| | that may be simulated in detail, and traces of memory accesses for all |
| | threads. The latter was used in step B to inform migration decisions, and |
| | in step C to model the memory traffic generated by the light sockets. The |
| | memory traces were processed in step B by the trace simulator and used |
| | in step C to generate the memory accesses of light sockets. Both trace |
| | types were generated on the same multi-threaded program run. The |
| | evaluation modeled a scaled-down 16-socket system with 4 cores per |
| | socket; hence, the study traced 64-thread program runs. |
| | The study combined the ChampSim tracer [1] and an existing Memory |
| | Access tracer [17], both of which were Intel Pintool-based [36]. Memory |
| | traces were generated for the entire program run, while instruction traces |
| | were generated at each checkpoint for the number of instructions to be |
| | simulated at the cycle level in step C, as depicted in FIG. 7A. For memory |
| | access tracing, accesses were filtered using a simple cache model (sized |
| | according to the modeled system) such that only memory requests that |
| | missed in the last-level cache were recorded. |
| | The study defined migration and simulation phases by instruction count |
| | instead of cycles, as only instruction count information was available |
| | during tracing (step A) and trace simulation (step B). The study recorded |
| | memory traces at 1 billion instruction intervals, which the study referred |
| | to as a phase. The study also recorded the first 100 million instructions of |
| | each phase, as shown in FIG. 7A. All instruction counts mentioned were |
| | per thread. |
| Step B - Memory Trace | Before timing simulation, the study introduced a preliminary step that |
| Simulation | processed only the memory traces to make per-phase data migration |
| | decisions. For each phase, this trace simulator collected memory access |
| | information and made migration decisions at the end of the phase |
| | according to the implemented policy. |
| | The output of the trace simulation was a checkpoint containing the page- |
| | to-socket mapping at the end of each phase, as well as a list of migrations |
| | that should happen in the upcoming phase based on the implemented |
| | migration policy. This checkpoint was an enabler for the sampling-based |
| | simulation. The memory state at the start of, for example, the 5th phase |
| | was the result of cumulative migration decisions of the preceding four |
| | phases. These checkpoints can be used to launch step C's timing |
| | simulations in parallel, one per checkpoint. |
| Step C - Timing Simulation | The timing simulation model was based on an augmented version of |
| | ChampSim [1]. As the study modeled 16-socket systems, the study |
| | employed a mixed-modality approach. The timing simulation consisted of |
| | N parallel simulations, one per generated checkpoint. The inputs of each |
| | timing simulation model were the phase's corresponding memory and |
| | instruction traces collected in step A and memory map and migration |
| | decisions generated in step B. |
| | The study used 10 checkpoints per workload, 1 billion instructions apart, |
| | and simulated 10 to 100 million instructions (depending on the workload's |
| | instructions per cycle (IPC)) at each checkpoint. Each simulation was |
| | primed with a warm-up phase of 10 million instructions to warm the |
| | microarchitectural state. A workload's reported performance was derived |
| | by aggregating results across the simulation of the ten checkpoints. |

### Mixed-Modality Simulation.

FIG. 7B shows a high-level overview of the mixed-modality simulation for a multi-socket system (e.g., system of the study and baseline system). The study employed ChampSim's detailed Out-of-Order core models to simulate a scaled-down four-core socket. The cores of the remaining 15 sockets (“light sockets”) were abstracted as load generators by utilizing the memory traces collected in step A, regulating their injection rate using the instructions per cycle (IPC) of the socket modeled in detail. Each light socket also modeled a memory controller to service memory requests that target its memory range while capturing performance effects such as memory scheduling and contention.

To model cross-socket latency and bandwidth limitations and any resulting contention, the study added a simulation layer between the last-level cache and the memory controller of each processor. This interconnect module modeled the intersocket topology, providing a configurable definition of latency and bandwidth per link. Upon a new memory access request, the destination socket was determined by looking up the page map input generated by step B. The interconnect module then determined the sequence of links the memory request had to traverse based on the request's source/destination socket. After traversing the interconnect, the request was injected into the destination socket's memory controller queue.

### Migration Policy Modeling.

The study demonstrated the potential utility of the system's memory pool in mitigating long NUMA latencies, so the study based the evaluation on an optimistic monitoring and migration policy used for both the system and the baseline 16-socket NUMA system.

The first component of any migration mechanism was page hotness tracking, which was implemented via sampling. Instead of choosing a specific sampling implementation, the study assumed perfect monitoring for both the baseline and the systems, whereby migration decisions for the next phase were made based on full knowledge of every memory access that occurred in the past phase. The data movement incurred by the migrations was captured in the timing simulation. As shown in FIG. 7A, step B determined migrations that should happen in phase i based on the memory accesses observed during the 1 billion instructions (per thread) of the previous phase i−1. While the entirety of these migrations was performed in the trace simulations, given that step C only performed cycle-level timing simulation for the first 100 million instructions (per thread) of each phase, only the top-ranked 10% migrations were used as input for step C and performed during timing simulation.

Finally, FIG. 7C shows an algorithm for the migration decision policy that the study applied in the system and the baseline 16-socket system. The study assumed that the input to the algorithm was a list of all accessed pages along with the access count per socket, sorted by their total access count in the previous phase.

The timing simulation accounted for all the data movement due to migrations by modeling them on the simulated bandwidth-limited network topology. The simulator read the list of pages to be migrated in the simulated phase (generated in step B) and modeled the data movement overhead by injecting memory traffic from the source to the destination socket. Migration was paced such that one page was being migrated between a pair of sockets at a time. The study additionally modeled the overhead of page table updates and translation look-aside buffer (TLB) shootdowns required for each migration. The study modeled a cost of 1450 cycles on each processor core involved in a migrating page [54]: one core on the source socket initiating the TLB shootdown and any other core that had previously accessed the migrating page and might thus be caching a now-stale translation for the page.

### System Configurations.

Table 2 shows the parameters of the system implemented as a full-scale 16-socket system modeled after an HPE Superdome Flex configuration [26].

TABLE 2

| | |
|---|---|
| CPU | OoO cores, 2.4 GHz, 4-wide, 256-entry ROB |
| L1 | 32 KB L1-I & L1-D, 8-way, 64 B blocks, 4-cycle |
| | access |
| L2 | 1 MB, 16-way, 14-cycle access |
| LLC | 2 MB/core, 16-way, 50-cycle access, shared (per |
| | socket) & non-inclusive |
| Memory | DDR5-4800, 32 GB per channel, 6 channels per socket |
| Topology | 28 cores per socket, 16 sockets |
| Link BW | 20 GB/s per ultra path UPI link, 13 GB/s per NUMA |
| | link |
| Remote Access | 50 ns (within chassis group), 280 ns (inter-chassis) |
| Latency Penalty | |

CXL Device

| | |
|---|---|
| Memory | DDR5-4800, 32 GB per channel, 24 channels |
| Pool BW | 20 GB/s per direction supported from each socket |
| Latency Penalty | 100 ns |

To make the simulation practical, the study scaled down the system to 4 cores per socket, adjusting the rest of the system's parameters accordingly to match the reduced traffic. The number of memory channels on each socket and the pool (thus their capacity and bandwidth) were scaled down commensurately. The bandwidth of the UPI links, NUMAL links, and CXL links to the pool was scaled down accordingly. Table 3 shows the scaled-down system parameters configured for simulation.

TABLE 3

| | |
|---|---|
| Caches | Per-core provisioning unchanged (see Table 2) |
| Memory | 1 channel per socket |
| Topology | 4 cores per socket |
| Link BW | 3 GB/s per UPI link or NUMALink |

CXL Device

| | |
|---|---|
| Memory | 1 channel |
| Device BW | 3 GB/s per direction supported from each socket |

### Workloads.

The study utilized applications from two benchmark suites: graph analytics applications and high-performance computing (HPC) workloads. Table 4 shows the descriptions of the applications from the two benchmark suites (e.g., graph analytics and HPC workloads).

TABLE 4

| Bench- | |
|---|---|
| mark | |
| suite | Description |
| Graph | The study deployed four graph analytics applications from the |
| ana- | GAP benchmark suite [8]: Breadth-First Search (BFS), |
| lytics | Connected Components (CC), Single-Source Shortest Paths |
| | (SSSP), and Triangle Counting (TC). The benchmarks operated |
| | on a Kronecker graph with 2²⁸ vertices and an average |
| | degree of 16, using around 50 GB of memory. |
| HPC | The study deployed two genomics analysis pipelines from |
| work- | GenomicsBench [48]: Full-Text Index in Minute Space (FMI) |
| loads | and Partial-Order Alignment (POA). |

Table 5 summarizes the IPC and last-level cache miss per kilop instructions (LLC MPKI) of the evaluated workloads as measured on the baseline 16-socket NUMA system.

TABLE 5

| Application | IPC | LLC MPKI | Application | IPC | LLC MPKI |
|---|---|---|---|---|---|
| BFS | 0.16 | 40 | TC | 0.43 | 3.4 |
| CC | 0.19 | 19 | FMI | 0.66 | 3.0 |
| SSSP | 0.09 | 75 | POA | 0.62 | 33 |

### AMAT Reduction Using a Memory Pool.

The study employed a memory pool to ameliorate the challenge of long-latency memory access in NUMA systems. FIG. 7D shows an example distribution of access types and expected average memory access time (AMAT) for the baseline 16-socket system and the system. Subpanel (a) shows the distribution of memory accesses for several graphs and HPC workloads deployed on a baseline 16-socket system, as well as the same system enhanced with a memory pool directly accessible by every socket (e.g., the system). Despite migrating pages closer to their requesting sockets, up to 75% (62% on average) of memory accesses in the baseline system are costly 2-hop ones. The system can convert most 2-hop accesses to memory pool accesses, resulting in an average of 41% pool accesses and 30% 2-hop accesses.

Subpanel (b) shows a first-order estimation of the AMAT resulting from the access distributions, derived as % local access×80 ns+% intra-chassis access×130 ns+% inter-chassis access×360 ns+% memory pool access×180 ns. The large fraction of remote accesses increases AMAT by up to 3.8× over the ideal AMAT of 80 ns in the baseline system. The results of this first-order analysis exemplify the memory pool's utility: by shrinking the fraction of costly 2-hop accesses and redirecting them to the memory pool, the system reduces AMAT by 20%.

### Evaluation Results.

The study evaluated the system (“StarNUMA”) against the baseline multi-socket NUMA system (e.g., 16-socket). The evaluation comprised several sensitivity experiments, including page migration volume and characteristics of the memory pool: access latency, bandwidth availability, and capacity.

### Main Results.

As discussed above, the study configured the provisioning memory capacity on the system's memory pool to be equivalent to the aggregate memory on a single chassis (4 sockets). However, the working sets of workloads during the simulation's limited execution window were smaller than the supported capacity. To enforce a capacity constraint even for workloads that operated on data that could fit in the memory pool's absolute capacity, the study limited the amount of data in the pool as a fraction of the memory used by the workload rather than a fixed value. Therefore, for the main evaluation, the study limited the memory pool's capacity to 20% of the total memory touched by the application throughout the simulation's execution window to emulate a pool that adds memory capacity equivalent to a fifth chassis. Additionally, for each workload-system combination, the study used the migration volume per phase that resulted in the best performance.

FIG. 7E shows the speedup and AMAT of the system versus the baseline system. As shown, across all workloads, the system achieved an average speedup of 1.13× against the baseline NUMA system. BFS, CC, and TC were good examples where placing shared data in the memory pool led to an AMAT reduction of 23-35%, resulting in over 20% performance improvement.

SSSP experienced a slowdown on the system because of congestion in the CXL links to the memory pool. The number of accesses to the pool in the system was higher than inter-chassis accesses in the baseline system, indicating that the baseline absorbed several accesses within the well-provisioned intra-chassis network. For the system, both intra-chassis accesses and inter-chassis accesses in the baseline were directed to the pool. With an already bandwidth-congested system, this increased number of accesses exacerbated the queuing delay to access the pool, leading to longer AMAT and slowdown. This shortcoming can be addressed with an alternative bandwidth-aware migration policy that limits the number of pages placed in the pool when such pressure is detected.

Like SSSP, BFS experienced a network bandwidth bottleneck in the baseline system, leading to high AMAT. However, unlike SSSP, memory traffic ended up better distributed between the pool and the inter-chassis network in the system. Due to a low migration limit compared to the size of the data that was popular across sockets, only a fraction of such shared pages made it to the pool. The result was an effective distribution of traffic between remote sockets and the pool, thus avoiding the bandwidth bottleneck the system encountered with SSSP. BFS demonstrated a case where the system can utilize the extra bandwidth in the pool without overwhelming it.

Finally, FMI benefited from the system, while POA was insensitive. All accesses in POA were local hence no migration occurred, and no data was placed in the pool. POA represented workloads with localized accesses, where a simple first-touch page placement policy alone prevented all NUMA effects.

### Impact of Migration Intensity.

Page migration is a method to reduce AMAT by improving locality and minimizing long-latency memory accesses. However, as each page migration entails data movement and TLB shootdown overheads, determining the optimal migration volume can depend on the workload. Therefore, the study performed a sensitivity experiment to determine the best migration volume for each workload-system combination. In each case, the study migrated the top-n pages, where the value of n varied, indicating the number of pages migrated at each phase.

FIG. 7F shows performance results for different migration volumes using various graph analytics applications (e.g., BFS, CC, SSSP, TC, FMI, POA, MEAN). In subpanel (a), in the baseline system, the majority of workloads exhibited best performance with no migration at all. Only TC benefited from migration, achieving 1.12× and 1.28× speedup when migrating 2,000 and 8,000 pages per phase, respectively. SSSP and FMI experienced a slowdown due to increased migration, resulting from overhead from TLB shootdown stalls and additional memory bandwidth pressure on the interconnect. BFS, CC, and POA were insensitive to migration volume.

Subpanel (b) shows the same results for the system. In contrast to the baseline system, the majority of workloads benefited from migration, as the memory pool served many accesses to vagabond pages. TC experienced a speedup of 1.33× even with a moderate 2,000-page migration limit per phase. The set of shared pages for TC was small, and the system migrated most of them to the memory pool punctually, even with a lower migration limit; hence, increasing migrations to 8,000 per phase yielded marginal gains. FMI was a similar case but with a lower performance gain.

Unlike TC, CC benefited from more aggressive migration. CC had more shared pages, so allowing them to move to the pool at a higher rate resulted in better performance. Similar to CC, BFS had a large amount of shared data that was accessed frequently across many processors, and put more of such pages in the pool with an 8,000 migration limit per phase. However, with the aggressive migration policy, more pages in the memory pool led to contention at the CXL links, resulting in a slowdown compared to a more moderate migration limit. Without the bandwidth bottleneck on the CXL interconnect, BFS would benefit from more aggressive migration, similar to CC.

SSSP lost performance with the system because the system converted even some local and single-hop accesses to memory pool accesses, creating more contention on the CXL port than the baseline experiences on the NUMALink to the remote ASIC. The migration data movement overheads further exacerbated this bottleneck.

For the rest of the evaluation, the study individually chose the migration intensity that delivered the best performance for each workload-system combination (e.g., for BFS, no migration for the baseline system and 2,000 migrations for the system).

### Impact of Memory Pool Latency.

The study evaluated the system's sensitivity to the latency cost of reaching the memory pool. In addition to the default system's 95 ns latency overhead, the study also evaluated a 185 ns overhead. This value represented the resulting latency overhead assuming an intermediate CXL switch, resulting in an unloaded end-to-end memory pool access latency of 270 ns, still 25% lower than a 2-hop access.

FIG. 7G shows the latency sensitivity results. BFS and SSSP did not exhibit a significant change in speedup, as the performance was dominated by queuing delay on the congested inter-chassis and CXL links. CC and TC still benefited from the system, but their speedup was reduced to 1.13× and 1.07×, respectively. FMI experienced a slowdown with the increased latency to the pool, as some local and single-hop accesses in the baseline convert to pool accesses in STARNUMA and suffer significant latency penalty. Across all applications, the increased latency overhead brought the system's average speedup from 1.13× down to 1.05×.

### Impact of Bandwidth Availability.

Some analytics applications used in the study experienced congestion from a bandwidth bottleneck in either inter-chassis or pool accesses. Scaling the bandwidth of the CXL links to the pool may not require significant changes to the architecture. Doubling (or even quadrupling) the bandwidth of the CXL links to the pool by using 8-lane (or 16-lane) ports may be straightforward and have modest pin requirements on the sockets. For this sensitivity analysis, the study evaluated the system's performance with 2× bandwidth to the MHD. For comparison, the study also included results for the baseline 16-socket system, which had double the bandwidth on each coherent link (both intra- and inter-socket). The aggregate bandwidth overprovisioning for the baseline system was higher than for the system, which only doubled the bandwidth of the CXL ports that connected to the pool, as the 16-socket system featured a total of 68 coherent links (28 inter-chassis and 40 intra-chassis) versus only 16 CXL links.

FIG. 7H shows the results for three different system/bandwidth provisioning combinations, normalized to the performance of the baseline multi-socket system. Applications such as CC and TC, which did not experience significant queuing delays due to bandwidth bottlenecks, marginally benefited from the extra bandwidth. BFS gained a moderate speedup from the added bandwidth, and the system converted the performance loss in SSSP to a 1.46× speedup with the 2× bandwidth boost. Baseline-2× outperformed both versions of the system for SSSP, because even with doubled bandwidth, the system experienced a bandwidth bottleneck as too many accesses went to the memory pool, the CXL link became a bottleneck, while the baseline spread the same accesses over more inter-chassis links. Finally, Baseline-2× outperformed the system in BFS. BFS had spread out intra-chassis accesses, hence benefited from the increased bandwidth to its single-hop neighbors. However, the system (STARNUMA-2×) slightly outperformed Baseline-2×, with a more modest overprovisioning of absolute aggregate bandwidth.

### Impact of Memory Pool Capacity.

Throughout the evaluation, the study assumed that the featured a memory pool with capacity equivalent to one chassis' (i.e., four sockets) worth of memory, thus representing 20% of the entire system's memory capacity. The study now examined the system's performance with a smaller pool capacity, equivalent to that of a single socket. The study enforced the capacity limit by the ratio of the memory used, rather than an absolute size limit. Thus, the study limited the memory pool's capacity to 1/17 of the total amount of memory touched by each workload.

FIG. 7I shows the system's performance sensitivity to the capacity of its memory pool, relative to the baseline multisocket system. With a 4× capacity reduction, the system's average speedup dropped from 1.13× to 1.09×. TC was the most affected workload; while still experiencing speedup, gains dropped from 1.28× to 1.09×. FMI was also negatively affected by the smaller pool, with the smaller-capacity system only marginally outperforming the baseline. Finally, BFS and CC were insensitive to the pool size, indicating that a high fraction of all accesses targeted a small fraction of pages that still fit in the memory pool.

### Discussion

Modem enterprises rely on multi-socket systems to deploy workloads requiring many cores with direct access to large shared memory capacity. While the multi-socket system market is dominated by machines with two to four sockets, there is a need for large-scale systems with 16 sockets or more. Such systems are typically used in high-performance computing (HPC) and transaction processing/banking that require thousands of threads and direct access to terabytes of shared memory. Despite driving a small portion of the server market in terms of volume, such large-scale multi-socket systems represent a market of $5 billion in annual revenue [50].

To scale up to 16+ sockets, processors are interconnected in a hierarchical fashion, leading to Non-Uniform Memory Access (NUMA). In other words, while every processor can directly access any memory location, memory access bandwidth/latency characteristics are dictated by the target memory module's distance from the accessing processor, as a function of hop count required on the coherent interconnect [7], [26]. To illustrate, in a HPE or IBM 16-socket system, the gap between the slowest and fastest memory access exceeds 4×, with an unloaded remote memory access latency of up to 360 ns [7], [26]. Techniques that minimize the fraction of long-latency accesses via intelligent data placement and migrations are therefore essential in large NUMA systems. Unfortunately, some workloads, such as graphs, exhibit challenging irregular access patterns, resulting in a large fraction of pages without a dedicated home socket location, referred to as vagabond pages. Vagabond pages hurt performance, either by triggering excessive migrations or by incurring many costly remote memory accesses.

To address this challenge, the study developed a system that extends a typical multi-socket system with a new architectural block, a memory pool, which is accessible by every socket in a single interconnect hop. By identifying vagabond pages and placing them in the memory pool, the system can minimize costly multi-hop remote memory accesses. The evaluation in the study on a 16-socket configuration using graph and HPC workloads showed an achieved average memory access latency reduction of 9%, yielding a performance gain of 1.13× on average and up to 1.29×.

Recent technological trends can render the system a timely and practical solution. The Compute Express Link (CXL) interconnect [14], which is based on a widely adopted open industry standard, supports all the required features to construct the system's memory pool. First, the CXL protocol supports coherent sharing of disaggregated memory devices across multiple sockets. Second, for the limited scale of our target multi-socket system, CXL's performance characteristics allow direct connectivity of every socket to the memory pool, at a latency that is 2× lower than the highest multi-hop latency of the baseline system. By selectively placing vagabond pages in this memory pool, the system can achieve a lower average memory access latency than a typical large NUMA system.

### Large-Scale Non-Uniform Memory Access (NUMA).

A 16-socket HPE Superdome FLEX [24], [28], [50] is an instance of a baseline multi-socket NUMA system; IBM Power10 multi-socket systems are similar [25]. The baseline 16-socket system can be organized into four chassis, each housing four sockets. This modular design facilitates the system to scale to 32 sockets by doubling the number of chassis. Each of the four sockets in the same chassis can be directly connected to each other with three UPI links. Depending on the number of supported UPI links of the used socket, some implementations only connect each socket to two other sockets, resulting in some pair-wise intra-chassis socket communications requiring two link crossings.

All sockets of the chassis in NUMA systems can connect to custom inter-socket link ASICs (FLEX ASICs) that provide inter-chassis connectivity [7], [24], [50]. Each FLEX ASIC features enough links to provide direct (i.e., single-hop) connectivity to every other FLEX ASIC in the system. To differentiate from intra-chassis UPI links, inter-chassis coherent links can be referred to as NUMALinks, and the term “coherent links” can be used to refer to both link types.

The hierarchical interconnection of the NUMA system's 16 sockets can reduce the number of required inter-chassis links to 28 (C₂⁸ combinations, with two FLEX ASICs per chassis), whereas directly connecting each of the 16 sockets may require 120 links (C₂¹⁶ combinations). However, the hierarchical interconnection can introduce latency implications, as memory access latency can depend on the relative location of the communicating pair of sockets, thus exacerbating the NUMA system's non-uniform memory access behavior.

Thanks to tight intra-chassis connectivity, accessing the memory of any other socket within the chassis requires a single UPI link traversal, adding a 50 ns latency penalty over local memory access. Accesses to memory located outside the chassis can take 360 ns, corresponding to a latency penalty of approximately 280 ns over local accesses, as reported in previous studies [7], [26]. The latency overhead can include traversing two UPI links (connecting the socket to the FLEX ASIC at each end), two FLEX ASICs, and an inter-chassis NUMALink twice. As a result, the (unloaded) latency of a memory access in such a 16-socket system is 80 ns, 130 ns, or 360 ns, depending on whether the target memory location is local, in another socket of the same chassis, or in a remote chassis. The widespread memory access latency implies that the Average Memory Access Time (AMAT) of a workload deployed on a multi-socket machine can be directly affected by its memory access pattern, which can in turn impact its resulting performance.

There are several mechanisms for intelligent page placement and movement aimed at mitigating the detrimental effect of long NUMA latencies that inflate AMAT. However, the most challenging workloads exhibit a significant fraction of memory accesses to pages that lack an optimal home socket location.

### NUMA Systems and Data Placement.

The origin of NUMA systems dates back to the early 1990s, a period marked by significant research activity on the design of large multiprocessor systems known as Distributed Shared Memory (DSM). The goal of DSM systems was to enable distributed, fast access to a large, physically distributed but logically shared memory, and they are coarsely classified into software and hardware DSMs. Software-based DSMs rely on software mechanisms, typically in the operating system (OS), to “fault in” remote memory accesses, at page [6], [12], [34] or finer [45], [46] granularity. As it is software's responsibility to maintain coherence by propagating changes, software DSMs incur high performance overheads, even when employing relaxed memory models. Modem software DSM incarnations constructed over fast RDMA networks [20], [23], [52]alleviate data movement overheads, but still encounter software bottlenecks.

Hardware DSMs, also known as cache-coherent NUMA (ccNUMA) systems, utilize hardware to facilitate transparent, cache-coherent sharing of physical memory. Multisocket NUMA architectures descend from such ccNUMA systems. Prominent representatives of early ccNUMA systems include the MIT Alewife [3], Stanford Flash [30] and Dash [32], Typhoon [43], Fugu [37], and commercial products such as Sun's Wildfire [41]. While the underlying hardware transparently identifies the location of each accessed cache block and performs the necessary data movements, frequent remote memory accesses are detrimental to the memory system's overall performance. Hence, data placement, which is typically governed at page granularity in software by the OS, plays a critical role in a ccNUMA system's performance.

Due to its impact on performance, page placement has been investigated with the advent of ccNUMA systems and remains an active research topic for multi-socket machines, as well as heterogeneous and tiered memory systems comprising multiple different memories with varying characteristics and constraints. Previous studies on ccNUMA systems demonstrated that judicious data placement and migration can impact performance [10], [11], [31], [38], [53]. Previous studies focused on software mechanisms that optimize data placement and movement in NUMA and/or tiered memory systems of various characteristics [4], [15], [29], [39], [40]. Doudali et al. highlighted the importance of selecting the optimal page migration frequency in hybrid memory systems [16] and developed a mechanism that leverages machine learning to tune it [18]. AutoTiering [29] advocated for specialized page placement and migration policies, emphasizing the importance of tailoring these mechanisms to the precise characteristics of the memory system they operate on. Consequently, using the exemplary system effectively can require developing a page management mechanism that is aware of the memory pool's unique features.

Another technique to increase the fraction of local memory accesses and mitigate NUMA effects is selective data replication, such as replication of read-only pages [53]. R-NUMA's hardware FSM dynamically identifies opportunities for selective replication of individual cache blocks, even within readwrite pages [21]. Mitosis [2] and NrOS [9]provided targeted NUMA-effect mitigations by extending the OS to selectively replicate page tables and kernel state across sockets, while Dvé [42]developed hardware that performs cross-socket replication to improve performance and resilience. In general, replication is an orthogonal approach to the exemplary system that wastes memory capacity and incurs costly software-based coherence actions upon modification of replicated data.

The exemplary system's provides a memory pool that is directly accessible by all sockets as a new building block for NUMA systems, to facilitate placement of vagabond pages for long-latency NUMA latency mitigation. While not tied to CXL, the study advocated for a CXL-based implementation due to the technology's versatility and open standard, which is gaining widespread industry adoption. As CXL has the potential of being transformative in many dimensions of memory system design, the technology has garnered significant research attention. Sun et al. characterized first-generation CXL memory devices and developed guidelines for practical use in future systems [49]. Cho et al. leveraged CXL's bandwidth superiority over DDR to redesign the memory system of high-throughput servers [13]. DirectCXL is one of the first system prototypes enabling CXL-based memory disaggregation, demonstrating superiority over prior equivalent RDMA-based solutions [22]. Both DirectCXL and Pond [33] demonstrated use cases of sharing a pool of CXL-attached memory across multiple hosts. Both systems focused on scale-out architectures and flexible partitioning, rather than active sharing, of the memory pool across hosts. In contrast, the exemplary system demonstrates the utility of a memory pool in the context of a scale-up architecture, where all memory is actively shared by all sockets.

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] “ChampSim.” [Online]. Available: https://github.com/ChampSim/ChampSim
[2] R. Achermann, A. Panwar, A. Bhattacharjee, T. Roscoe, and J. Gandhi, “Mitosis: Transparently Self-Replicating Page-Tables for LargeMemory Machines,” in Proceedings of the 25th International Conference on Architectural Support for Programming Languages and Operating Systems (ASPLOS-XXV), 2020, pp. 283-300.
[3] A. Agarwal, R. Bianchini, D. Chaiken, K. L. Johnson, D. A. Kranz, J. Kubiatowicz, B.-H. Lim, K. Mackenzie, and D. Yeung, “The MIT Alewife Machine: Architecture and Performance,” in Proceedings of the 22nd International Symposium on Computer Architecture (ISCA), 1995, pp. 2-13.
[4] N. Agarwal and T. F. Wenisch, “Thermostat: Application-transparent Page Management for Two-tiered Main Memory,” in Proceedings of the 22nd International Conference on Architectural Support for Programming Languages and Operating Systems (ASPLOS-XXII), 2017, pp. 631-644.
[5] AMD, “4th Gen AMD EPYC processor architecture.” [Online]. Available: https://www.amd.com/system/files/documents/4th-genepyc-processor-architecture-white-paper.pdf
[6] C. Amza, A. L. Cox, S. Dwarkadas, P. Keleher, H. Lu, R. Rajamony, W. Yu, and W. Zwaenepoel, “Treadmarks: Shared memory computing on networks of workstations,” IEEE Computer, 1996.
[7] T. Bang, N. May, I. Petrov, and C. Binnig, “The full story of 1000 cores,” VLDB J., vol. 31, no. 6, pp. 1185-1213, 2022.
[8] S. Beamer, K. Asanovic, and D. A. Patterson, “The GAP Benchmark Suite,” CoRR, vol. abs/1508.03619, 2015.
[9] A. Bhardwaj, C. Kulkarni, R. Achermann, I. Calciu, S. Kashyap, R. Stutsman, A. Tai, and G. Zellweger, “NrOS: Effective Replication and Sharing in an Operating System,” in Proceedings of the 15th Symposium on Operating System Design and Implementation (OSDI), 2021, pp. 295-312.
[10] D. L. Black, A. Gupta, and W.-D. Weber, “Competitive management of distributed shared memory,” in Thirty-Fourth IEEE Computer Society International Conference: Intellectual Leverage, 1989, pp. 184-190.
[11] M. Bull and C. Johnson, “Data distribution, migration and replication on a cc-numa architecture,” 2002.
[12] J. B. Carter, J. K. Bennett, and W. Zwaenepoel, “Implementation and Performance of Munin,” in Proceedings of the 13th ACM Symposium on Operating Systems Principles (SOSP), 1991, pp. 152-164.
[13] A. Cho, A. Saxena, M. K. Qureshi, and A. Daglis, “A Case for CXLCentric Server Processors,” CoRR, vol. abs/2305.05033, 2023.
[14] CXL Consortium, “Compute Express Link (CXL) Specification, Revision 3.0, Version 1.0,” 2022. [Online]. Available: https://www.computeexpresslink.org/_files/ugd/Oc1418_1798ce97cle6438fba818d760905e43a.pdf
[15] M. Dashti, A. Fedorova, J. R. Funston, F. Gaud, R. Lachaize, B. Lepers, V. Quéma, and M. Roth, “Traffic management: a holistic approach to memory placement on NUMA systems,” in Proceedings of the 18th International Conference on Architectural Support for Programming Languages and Operating Systems (ASPLOS-XVIII), 2013, pp. 381-394.
[16] T. D. Doudali, D. Zahka, and A. Gavrilovska, “The Case for Optimizing the Frequency of Periodic Data Movements over Hybrid Memory Systems,” in Proceedings of the 2020 International Symposium on Memory Systems (MEMSYS), 2020, pp. 137-143.
[17] T. D. Doudali, D. Zahka, and A. Gavrilovska, “Cori: Dancing to the right beat of periodic data movements over hybrid memory systems,” in 2021 IEEE International Parallel and Distributed Processing Symposium (IPDPS), 2021, pp. 350-359.
[18] T. D. Doudali, D. Zahka, and A. Gavrilovska, “Cori: Dancing to the Right Beat of Periodic Data Movements over Hybrid Memory Systems,” in Proceedings of the 35th IEEE International Symposium on Parallel and Distributed Processing (IPDPS), 2021, pp. 350-359.
[19] EE Times, “CXL will absorb Gen-Z,” 2021. [Online]. Available: https://www.eetimes.com/cxl-will-absorb-gen-z/
[20] W. Endo, S. Sato, and K. Taura, “MENPS: A Decentralized Distributed Shared Memory Exploiting RDMA,” in Fourth IEEE/ACM Annual Workshop on Emerging Parallel and Distributed Runtime Systems and Middleware (IPDRM), 2020, pp. 9-16.
[21] B. Falsafi and D. A. Wood, “Reactive NUMA: A Design for Unifying S-COMA and CC-NUMA,” in Proceedings of the 24th International Symposium on Computer Architecture (ISCA), 1997, pp. 229-240.
[22] D. Gouk, S. Lee, M. Kwon, and M. Jung, “Direct Access, HighPerformance Memory Disaggregation with DirectCXL,” in Proceedings of the 2022 USENIX Annual Technical Conference (ATC), 2022, pp. 287-294.
[23] J. Gu, Y. Lee, Y. Zhang, M. Chowdhury, and K. G. Shin, “Efficient Memory Disaggregation with Infiniswap,” in Proceedings of the 14th Symposium on Networked Systems Design and Implementation (NSDI), 2017, pp. 649-667.
[24] Hewlett Packard Enterprise, “HPE Superdome Flex Servers,” 2023, accessed: 2023-08-10. [Online]. Available: https://www.hpe.com/us/en/servers/superdome.html
[25] IBM, IBM Power E1080 Data Sheet, 2021, accessed: 2023-08-10. [Online]. Available: https://www.ibm.com/downloads/cas/MMOYB4YL
[26] C. Imes, S. Hofmeyr, D. I. D. Kang, and J. P. Walters, “A case study and characterization of a many-socket, multi-tier numa hpc platform,” in IEEE/ACM 6th Workshop on the LLVM Compiler Infrastructure in HPC (LLVM-HPC) and Workshop on Hierarchical Parallelism for Exascale Computing (HiPar), 2020.
[27] J. Jaffari, A. Ansari, and R. Beraha, “Systems and methods for a hybrid parallel-serial memory access,” 2015, U.S. Pat. No. 9,747,038B2.
[28] Kaon Interactive, “HPE Superdome Flex Interactive,” 2023, accessed: 2023-08-10. [Online]. Available: https://apps.kaonadn.net/5185710160084992/product.html#1/199; C187
[29] J. Kim, W. Choe, and J. Ahn, “Exploring the Design Space of Page Management for Multi-Tiered Memory Systems,” in Proceedings of the 2021 USENIX Annual Technical Conference (ATC), 2021, pp. 715-728.
[30] J. Kuskin, D. Ofelt, M. A. Heinrich, J. Heinlein, R. Simoni, K. Gharachorloo, J. Chapin, D. Nakahira, J. Baxter, M. Horowitz, A. Gupta, M. Rosenblum, and J. L. Hennessy, “The Stanford FLASH Multiprocessor,” in Proceedings of the 21st International Symposium on Computer Architecture (ISCA), 1994, pp. 302-313.
[31] R. P. LaRowe, M. A. Holliday, and C. S. Ellis, “An Analysis of Dynamic Page Replacement on a NUMA Multiprocessor,” in Proceedings of the 1992 ACM SIGMETRICS International Conference on Measurement and Modeling of Computer Systems, 1992, pp. 23-34.
[32] D. Lenoski, J. Laudon, K. Gharachorloo, W.-D. Weber, A. Gupta, J. L. Hennessy, M. Horowitz, and M. S. Lam, “The Stanford Dash Multiprocessor,” Computer, vol. 25, no. 3, pp. 63-79, 1992.
[33] H. Li, D. S. Berger, S. Novakovic, L. Hsu, D. Ernst, P. Zardoshti, M. Shah, S. Rajadnya, S. Lee, I. Agarwal, M. D. Hill, M. Fontoura, and R. Bianchini, “Pond: CXL-Based Memory Pooling Systems for Cloud Platforms,” Proceedings of the 28th International Conference on Architectural Support for Programming Languages and Operating Systems (ASPLOS-XXVIII), 2023.
[34] K. Li and P. Hudak, “Memory Coherence in Shared Virtual Memory Systems,” ACM Trans. Comput. Syst., vol. 7, no. 4, pp. 321-359, 1989.
[35] Linux, “Automatic NUMA Balancing,” 2014, https://www.linuxkvm.org/images/7/75/0lx07b-NumaAutobalancing.pdf.
[36] C.-K. Luk, R. Cohn, R. Muth, H. Patil, A. Klauser, G. Lowney, S. Wallace, V. J. Reddi, and K. Hazelwood, “Pin: Building customized program analysis tools with dynamic instrumentation,” SIGPLAN Not., vol. 40, no. 6, p. 190-200, jun 2005. [Online]. Available:
   https://doi.org/10.1145/1064978.1065034
[37] K. Mackenzie, J. Kubiatowicz, A. Agarwal, and M. F. Kaashoek, “Fugu: Implementing translation and protection in a multiuser, multimodel multiprocessor,” in 1994 Workshop on Shared Memory Multiprocessors, USA, 1994.
[38] M. Marchetti, L. I. Kontothanassis, R. Bianchini, and M. L. Scott, “Using simple page placement policies to reduce the cost of cache fills in coherent shared-memory systems,” 1995, pp. 480-485.
[39] H. A. Maruf, H. Wang, A. Dhanotia, J. Weiner, N. Agarwal, P. Bhattacharya, C. Petersen, M. Chowdhury, S. O. Kanaujia, and P. Chauhan, “TPP: Transparent Page Placement for CXL-Enabled Tiered-Memory,” in ASPLOS (3), 2023, pp. 742-755.
[40] Y. Moon, W. Doh, K. Kyung, E. Lee, and J. H. Ahn, “ADT: Aggressive Demotion and Promotion for Tiered Memory,” IEEE Comput. Archit. Lett., vol. 22, no. 1, pp. 21-24, 2023.
[41] L. Noordergraaf and R. van der Pas, “Performance Experiences on Sun's WildFire Prototype,” in Proceedings of the 1999 ACM/IEEE Conference on Supercomputing (SC), 1999, p. 38.
[42] A. Patil, V. Nagarajan, R. Balasubramonian, and N. Oswald, “Dv6: Improving DRAM Reliability and Performance On-Demand via Coherent Replication,” in Proceedings of the 48th International Symposium on Computer Architecture (ISCA), 2021, pp. 526-539.
[43] S. K. Reinhardt, J. R. Larus, and D. A. Wood, “Tempest and Typhoon: User-Level Shared Memory,” in Proceedings of the 21st International Symposium on Computer Architecture (ISCA), 1994, pp. 325-336.
[44] R. Rooney and N. Koyle, “Micron® DDR5 SDRAM: New Features,” Micron Technology Inc., Tech. Rep, 2019.
[45] D. J. Scales, K. Gharachorloo, and C. A. Thekkath, “Shasta: A Low Overhead, Software-Only Approach for Supporting Fine-Grain Shared Memory,” in Proceedings of the 7th International Conference on Architectural Support for Programming Languages and Operating Systems (ASPLOS-VII), 1996, pp. 174-185.
[46] I. Schoinas, B. Falsafi, A. R. Lebeck, S. K. Reinhardt, J. R. Larus, and D. A. Wood, “Fine-grain Access Control for Distributed Shared Memory,” in Proceedings of the 6th International Conference on Architectural Support for Programming Languages and Operating Systems (ASPLOS-VI), 1994, pp. 297-306.
[47] D. D. Sharma, “Compute Express Link®: An open industry-standard interconnect enabling heterogeneous data-centric computing,” in Proceedings of the 2022 Annual Symposium on High-Performance Interconnects, 2022, pp. 5-12.
[48] A. Subramaniyan, Y. Gu, T. Dunn, S. Paul, M. Vasimuddin, S. Misra, D. T. Blaauw, S. Narayanasamy, and R. Das, “GenomicsBench: A Benchmark Suite for Genomics,” in Proceedings of the 2021 IEEE International Symposium on Performance Analysis of Systems and Software (ISPASS), 2021, pp. 1-12.
[49] Y. Sun, Y. Yuan, Z. Yu, R. Kuper, I. Jeong, R. Wang, and N. S. Kim, “Demystifying CXL memory with genuine cxl-ready systems and devices,” MICRO23, 2023.
[50] The Next Platform, “Big Iron Will Always Drive Big Spending,” 2021, https://www.nextplatform.com/2021/09/21/big-iron-willalways-drive-big-spending/.
[51] The Register, “CXL absorbs OpenCAPI on the road to interconnect dominance,” 2022. [Online]. Available: https://www.theregister.com/2022/08/02/cxl_absorbs_opencapi/
[52] R. Veldema and M. Philippsen, “Evaluation of RDMA Opportunities in an Object-Oriented DSM,” in 20th International Workshop on Languages and Compilers for Parallel Computing, 2007, pp. 217-231.
[53] B. Verghese, S. Devine, A. Gupta, and M. Rosenblum, “Operating System Support for Improving Data Locality on CC-NUMA Compute Servers,” in Proceedings of the 7th International Conference on Architectural Support for Programming Languages and Operating Systems (ASPLOS-VII), 1996, pp. 279-289.
[54] C. Villavieja, V. Karakostas, L. Vilanova, Y. Etsion, A. Ramirez, A. Mendelson, N. Navarro, A. Cristal, and O. S. Unsal, “DiDi: Mitigating the Performance Impact of TLB Shootdowns Using a Shared TLB Directory,” in Proceedings of the 20th International Conference on Parallel Architecture and Compilation Techniques (PACT), 2011, pp. 340-349.
[55] R. E. Wunderlich, T. F. Wenisch, B. Falsafi, and J. C. Hoe, “SMARTS: Accelerating Microarchitecture Simulation via Rigorous Statistical Sampling,” in Proceedings of the 30th International Symposium on Computer Architecture (ISCA), 2003, pp. 84-95.

What is claimed:

1. A system comprising:
a memory pool configured with memory resources and service read and write requests to the memory resources;
one or more multi-CPU-socket chassis forming a high-performance computing (HPC) system, including a first multi-CPU-socket chassis, wherein the first multi-CPU-socket chassis has a plurality of sockets, wherein each socket of the first multi-CPU-socket chassis is operatively coupled to the memory pool, wherein the first multi-CPU-socket chassis comprises:
a plurality of processing units connected to the plurality of sockets, including a first processing unit; and
a plurality of local memories, including a first local memory, wherein the first local memory has instructions stored thereon, wherein execution of the instructions causes the plurality of processing units to:
allocate a memory resource, from the first local memory, for a computing process, wherein the allocated memory resource is accessible by each of the plurality of processing units of the first multi-CPU-socket chassis; and
migrate the allocated memory resource to the memory pool based on a number of tracked accesses to the allocated memory resource by the plurality of processing units, wherein the migrated allocated memory resource in the memory pool is directly accessible by the plurality of processing units without an access request being presented to the first processing unit.

2. The system of claim 1, wherein the one or more multi-CPU-socket chassis include a second multi-CPU-socket chassis having a second plurality of sockets,
wherein each socket of the second multi-CPU-socket chassis is operatively coupled to the memory pool,
wherein each of the second plurality of sockets is connected to a second plurality of local memories, and
wherein each of the second plurality of sockets is connected to the memory pool.

3. The system of claim 1, wherein each of the one or more multi-CPU-socket chassis has a respective plurality of processing units connected to a respective plurality of sockets,
wherein each of the respective plurality of sockets of each of the one or more multi-CPU-socket chassis is connected to a respective plurality of local memories, and
wherein each of the respective plurality of sockets of each of the multi-CPU-socket chassis is connected to the memory pool.

4. The system of claim 3, wherein each of the respective plurality of sockets is connected to the memory pool via a Compute Express Link (CXL).

5. The system of claim 4, wherein the memory pool is a multi-headed device (MHD) having one or more ports configured to support CXLs and CXL-enabled connections with each of the plurality of sockets.

6. The system of claim 4, wherein each of the respective plurality of sockets of each of the one or more multi-CPU-socket chassis is configured to transmit a page or cache line to subsequent multi-CPU-socket chassis via one or more inter-socket links of a respective inter-socket link application-specific integrated circuit (ASIC) of each of the one or more multi-CPU-socket chassis.

7. The system of claim 5, wherein the memory pool is located in the first multi-CPU-socket chassis.

8. The system of claim 5, wherein the memory pool is located in a separate circuitry.

9. The system of claim 1, wherein the migrated allocated memory resource is a joint page accessible by the plurality of processing units in a joint computing process.

10. The system of claim 1, wherein each of the plurality of sockets receives a microprocessor having a plurality of cores or chiplets as a subset of the plurality of processing units.

11. The system of claim 6, wherein execution of the instructions further causes the plurality of processing units to:
subsequent to allocating the memory resource, broadcast a notification message page or cache line, via one or more inter-socket links of a first inter-socket link ASIC of the first multi-CPU-socket chassis, notifying the subsequent multi-CPU-socket chassis of the presence of the allocated memory resource.

12. The system of claim 5, wherein the memory pool comprises a controller configured to receive a page or cache line from or transmit the page or cache line to a respective plurality of sockets of a multi-socket CPU chassis.

13. The system of claim 12, wherein execution of the instructions further causes the plurality of processing units to:
prior to migrating the allocated memory resource to the memory pool:
transmitting a request message page or cache line, via a CXL, to the controller of the memory pool requesting availability for storing the allocated memory resource; and
receiving, via the CXL, a reply message page or cache line from the controller of the memory pool indicating the availability for storing the allocated memory resource.

14. The system of claim 13, wherein execution of the instructions further causes the plurality of processing units to:
subsequent to migrating the allocated memory resource to the memory pool:
receiving, via the CXL, a confirmation message page or cache line from the controller of the memory pool confirming a completion of the migration of the allocated memory resource; and
broadcasting a notification message page or cache line, via the CXL, notifying subsequent multi-CPU-socket chassis of the presence of the allocated memory resource in the memory pool.

15. The system of claim 3, wherein the respective plurality of sockets of each of the one or more multi-CPU-socket chassis includes 2 to 64 sockets.

16. The system of claim 1, wherein the migration is handled by an operating system associated with the plurality of processing units, including the first processing unit.

17. The system of claim 16, wherein the migrated allocated memory resource is maintained by the operating system and owned by the plurality of processing units.

18. The system of claim 1, wherein the allocation of the memory resource occurs on the memory pool, wherein the allocated memory resource on the memory pool is directly accessible by the plurality of processing units without an access request being presented to the first processing unit.

19. A method comprising:
providing a memory pool configured with memory resources and service read and write requests to the memory resources, wherein the memory pool is accessible by a plurality of multi-CPU-socket chassis, including a first multi-CPU-socket chassis comprising (i) a plurality of processing units connected to a plurality of sockets, including a first processing unit and (ii) a plurality of local memories, including a first local memory;
allocating a memory resource from the first local memory for a computing process, wherein the allocated memory resource is accessible by each of the plurality of processing units of the first multi-CPU-socket chassis;
tracking accesses to the allocated memory resource by the plurality of processing units; and
migrating the allocated memory resource to the memory pool based on a number of tracked accesses, wherein the migrated allocated memory resource in the memory pool is directly accessible by the plurality of processing units without an access request being presented to the first processing unit.

20. The method of claim 19, wherein each of the plurality of sockets is connected to the memory pool via a Compute Express Link (CXL).

21. A method comprising:
providing a memory pool configured with memory resources and service read and write requests to the memory resources, wherein the memory pool is accessible by a plurality of multi-CPU-socket chassis, including a first multi-CPU-socket chassis comprising (i) a plurality of processing units connected to a plurality of sockets, including a first processing unit and (ii) a plurality of local memories, including a first local memory;
allocating a memory resource from the first local memory for a computing process; and
writing to the allocated memory resource of the memory pool based on the computing process, wherein the allocated memory resource in the memory pool is directly and natively accessible by the plurality of processing units without an access request being presented to one of the processing units.
